(19) United States
(12) Patent Application Publication
(10) Pub. No.: US 2007/0071585 A1
(43) Pub. Date: Mar. 29, 2007

(54) Shuttles for transporting goods

(76) Inventor: Claus Henkel, Cartersville, GA (US)

Correspondence Address: KILPATRICK STOCKTON LLP, 1001 WEST FOURTH STREET, WINSTON-SALEM, NC, 27101, US

(21) Appl. No.: 11/486,700

(22) Filed: Jul. 14, 2006

Related U.S. Application Data
(60) Provisional application No. 60/699,654, filed on Jul. 15, 2005.

(51) Int. Cl. B60P 1/04

(52) U.S. Cl. 414/471

(57) ABSTRACT

Conventional means of transporting goods, for example, in a warehouse tend to be expensive due to costs from human labor and from employing automation such as conveyors. Shuttles that are used to automatically transport goods provide a means of transporting goods that is less expensive, more efficient, and allows more rapid transportation. Shuttles, systems employing the shuttles, and methods of transporting goods using these shuttles, is disclosed.

The present application claims priority under 35 U.S. C. 119(e) to U.S. Provisional Application No. 60/699,654 filed Jul. 15, 2005, the entire contents of which are incorporated herein by reference.

### FIELD OF THE INVENTION

The present invention relates to goods transporting shuttles, methods of using said shuttles as well as systems that use these goods transporting shuttles. In particular, the present invention relates to shuttles and to methods and systems of transporting, loading and/or unloading, sorting, picking, feeding, storing, and retrieving goods employing goods transporting shuttles that is faster, more efficient, more flexible and cheaper than the traditional means of transporting, loading and/or unloading, sorting, picking, storing, and retrieving goods.

### BACKGROUND OF THE INVENTION

Conventionally, pallets, totes and other goods/cargo have been transported (for example, in warehouses) by employing forklifts and/or conveyors, with heavy emphasis on manual (i.e., human) labor. The use of forklifts, conveyors, and manual labor all have drawbacks.

Forklifts tend to be expensive and require the use of humans to drive the forklifts to transport cargo/goods/pallets around. Human labor is also notoriously expensive. Moreover, the use of human labor to transport products, goods, pallets and cargo around warehouses or other locations often requires that the people be well-trained. If well-trained employees are used, labor costs tend to be high. If the employees are not well trained, accidents may occur damaging goods and/or mistakes may occur in transporting the goods to a desired location.

Reduction in the amount of human labor has been achieved by the use of automation techniques such as the use of conveyors to aid in transporting goods/cargo/pallets. However, the use of conveyors has drawbacks in the warehouse setting or in any other setting where goods are required to be transported, stored in a given location, or unloaded from or loaded on to vehicles. Conveyors used to transport goods can be useful in two dimensional systems whereby one desires that a package tote and /or pallet be transported down an operation line. When conveyors are used, packages, totes, and /or pallets are transported serially meaning that one is limited to transporting the goods onto the conveyor and having the conveyor transport the goods to the desired location. The conveyor system often is the bottleneck that slows down the process of transporting, storing, loading and unloading goods. A- given conveyor is not very adaptable in its ability to position goods at different locations. A conveyor system tends to be able to transport goods from point A to point B, but fails to provide avenues for transporting goods to other locations (without adjusting the conveyor system). Conveyors also suffer from the drawback of not being able to easily transport a great variety of good types and sizes without active human intervention. It was with these conventional system drawbacks that the instant invention was developed.

### BRIEF SUMMARY OF THE INVENTION

The instant invention relates to a shuttle system, shuttles, and methods of transporting and storing goods around venues. The shuttle system of the present invention allows for loading or unloading, transporting or storage of large or small goods or objects, cartons, totes or pallets, to other locations of a venue, such as a warehouse or a vehicle. The system of the instant invention uses automation (i.e., the system can be used with minimal interaction from an operator). The instant invention allows parallel processing of goods including the loading, storing and unloading of goods, totes, packages, pallets or other objects. Several embodiments of the present invention are depicted in the drawings and are described in detail below. The shuttle system of the present invention employs shuttles to transport goods, which provides faster, cheaper, and more efficient means of transporting, loading or unloading, picking, sorting or storing goods.

### DESCRIPTION OF THE SEVERAL VIEWS OF THE DRAWING

FIGS. 1A-D show an exemplary embodiment of a shuttle for transporting, storing,loading or unloading goods.

FIG. 2 shows a shuttle with an attached dispenser in an A-frame like design dispensing goods into a container on the shuttle.

FIG. 3 shows a shuttle loading and/or unloading goods in a trailer of a tractor trailer.

FIG. 4 shows multiple goods on a series of shuttles.

FIGS. 5A-B show a top down view and a side view of a ramp for shuttles.

FIG. 6 shows a shuttle that is replenishing goods to a dedicated lane for picking (i.e., on a roller conveyor chute).

FIG. 7 shows a plurality of chutes that have goods delivered to the chutes by shuttles

FIG. 8 shows several shuttles picking from A-frame like channels.

FIGS. 9A-C show a shuttle that has an attachable dispenser.

FIGS. 10A-B show a means of sorting of cartons and totes and products.

FIG. 11A shows multiple parallel top-loader inductions that sorts with parallel shuttles.

FIG. 11B shows a top-loaded sorter in a side view.

FIGS. 12A-D show a series of shuttles, which are interlocked together to support a pallet.

FIG. 13 shows a method by which shuttles interlock in order to support pallets and/or heavier goods and to convey the pallet and/or heavier goods.

FIG. 14 shows a method by which shuttles interlock in order to support

FIGS. 15A-B show shuttles with interlocking design that can be used to support pallets and/or heavier goods.

FIG. 16 shows a stacker wherein unused shuttles can be stored or retrieved.

FIGS. 17A-B show another means of storing shuttles or goods and a means by which multiple shuttles in the same aisle can bypass each other.

FIG. 18 shows another in feed and out feed system for the storage/retrieval of shuttles and/or goods.

FIG. 19 shows a crane in a venue for the transport of pallets.

FIGS. 20A-C show a work station wherein a shuttle arrives wherein a person may be present.

FIG. 21 shows a plurality of workstations wherein goods are transported by shuttle from one workstation to another.

FIG. 22 shows an endless multilane multilevel parallel sorter.

FIG. 23 shows an exemplary embodiment of a warehouse layout utilizing the embodiments present in the instant invention.

FIG. 24 shows a palletizing robot with shuttles that lift and rotate to stack products on pallets.

FIGS. 25A-B show a shuttle that can be used for palletizing.

FIGS. 26A-B show a storage and retrieval system.

FIG. 27 shows a means for accessing pallets using shuttles.

FIGS. 28A-B show an inverted shuttle as an overhead system as well as an example of the overhead grid that allows movement of the inverted shuttles.

FIG. 29 shows interlocked shuttles that are able to accommodate an automobile bumper.

FIG. 30 shows a dispenser docking station for shuttles.

FIG. 31 shows a battery replacement docking station for shuttles.

### DETAILED DESCRIPTION OF THE INVENTION

The instant invention is first described generally and then described as it relates to the drawings. However, the description in relation to the drawings is in no ways meant to limit the appended claims to the shown embodiments. It should be apparent to those of ordinary skill in the art that alternative embodiments are possible and contemplated and within the scope of the instant invention.

For purposes of this application, when the word “goods” is used, it refers to one or more packages, totes, pallets, cargo, or any other entity that contains commodities that may be transported, loaded or unloaded, picked, sorted or stored.

Generally, the invention relates to shuttles for transporting goods, said shuttles possessing a plurality of wheels, a platform that is attached to the wheels by swivels, a lift that rests on top of the platform that lifts another platform that supports goods. The shuttles are also equipped with one or more motors, one motor is used to transport the shuttle from venue to venue, and another motor may be used to operate the lift. Alternatively, one motor may have several functions, for example being able to transport the shuttle while at the same time being able to operate the lift that lifts the goods supporting platform. Other functions that may be performed by the motors include the ability to pick up or deposit goods at a given location.

The shuttle may also be equipped with one or more RF-ID chips that allow a remote operator and the shuttle to discern the shuttle's geographical position, while also allowing the shuttle to communicate with other RF-ID chips on goods, other shuttles, or with selected locations in the venue where the shuttle is present. The shuttle optionally has an integrated RF-ID reader or barcode scanner or a combination of both, which allows product verification during pick-up and transport (alternatively, the RF-ID reader or barcode scanner may be present on the product or at the location and read an RF-ID on the shuttle). A shuttle that possesses an integrated RF-ID reader allows the shuttle to recognize desired goods that are bar-coded or possess an RF chip. When the shuttle recognizes the desired goods, the shuttle can pick-up the desired goods and transport those goods to another location and/or deposit goods at a desired location.

The shuttles of the instant invention also optionally have a computer that is associated with the shuttle. The computer instructs the shuttle to perform tasks using an algorithm or a computer program. The computer may be either physically connected to the shuttle, or alternatively, the computer may be present at a remote location from the shuttle. If a computer is present that is associated with the shuttle, it is preferred that an operator be able to pre-program or alternatively, to interactively program the computer to instruct the shuttle to perform tasks (as the shuttle is performing a given task).

Examples of tasks that the shuttle can perform include transporting goods to a given location, deposing those goods on to the ground or at a location other than the ground (such as deposing the goods to a sorter or a chute or to a workstation and the, like). Other tasks that the shuttle can perform include picking up goods, interconnecting with other shuttles, pushing or pulling other shuttles or any of the tasks that are mentioned elsewhere in this disclosure.

In an alternative embodiment of the invention, the shuttles may not possess wheels but may have a means of hanging the shuttles from the ceiling. In this embodiment, the shuttles possess a lift that allows a goods supporting platform to access goods from above. The lift transports the goods supporting platform up and down. In this embodiment, the shuttles are also able to transport goods from location to location. The shuttles also are equipped with one or more RF-ID chips that allow a remote operator and the shuttle to discern the shuttle's geographical position, while also allowing the shuttle to communicate with other RF-ID chips on goods, other shuttles, or with selected locations in the venue where the shuttle is present. The shuttles also optionally have a computer that is associated with the shuttle wherein the computer instructs the shuttle to perform tasks using and algorithm or a computer program. The computer may be either physically connected to the shuttle, or alternatively, the computer may be present at a remote location from the shuttle. If a computer is present that is associated with the shuttle, it is preferred that an operator be able to pre-program or alternatively, to interactively program the computer to instruct the shuttle to perform tasks.

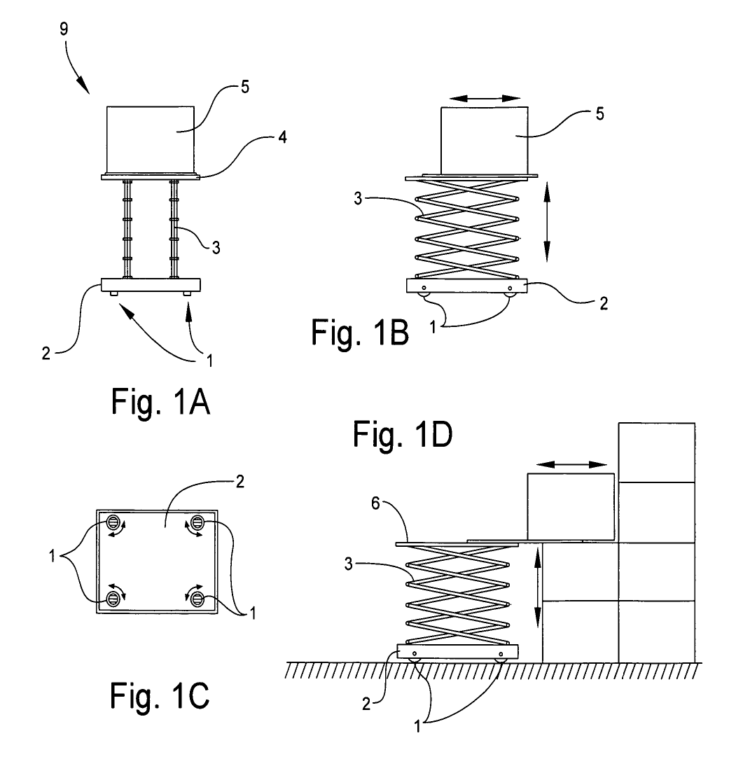

One embodiment and the simplest form of the invention can be seen in FIG. 1A-1D, wherein a shuttle 9 is shown from different perspectives. In this particular embodiment of the invention, FIG. 1A shows the shuttle from the side, FIG. 1B shows the shuttles from the front and FIG. 1C from the bottom, with wheels 1 at the bottom, a scissors lift supporting platform 2 attached to the wheels, with the scissors lift 3 attached to the scissors lift supporting platform 2, and a goods supporting platform 4 attached to the scissors lift 3. The scissors lift 3 can collapse so that the goods supporting platform 4 abuts or approaches the scissors lift supporting platform 2 and the scissors lift 3 can expand so that the goods supporting platform raises the goods 5 to a desired level so that the goods 5 can be transported to a desired location. The scissors lift 3 generally is controlled by a motor (not shown) so that the scissors lift 3 can support the goods supporting platform 4 (supporting or not supporting goods) in a desired position (i.e., either the collapsed position, a partially expanded position, or a fully expanded position).

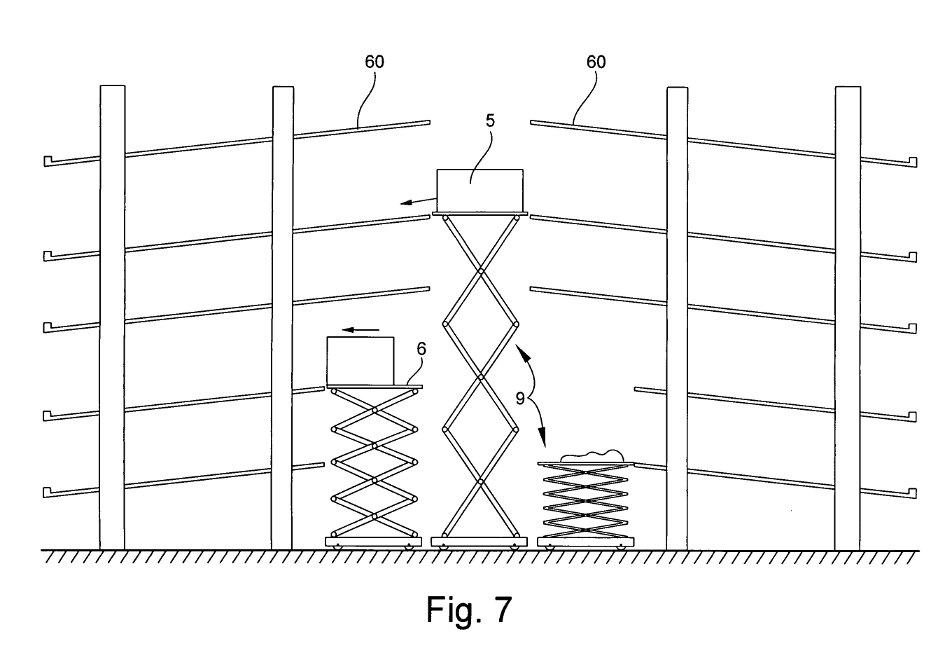

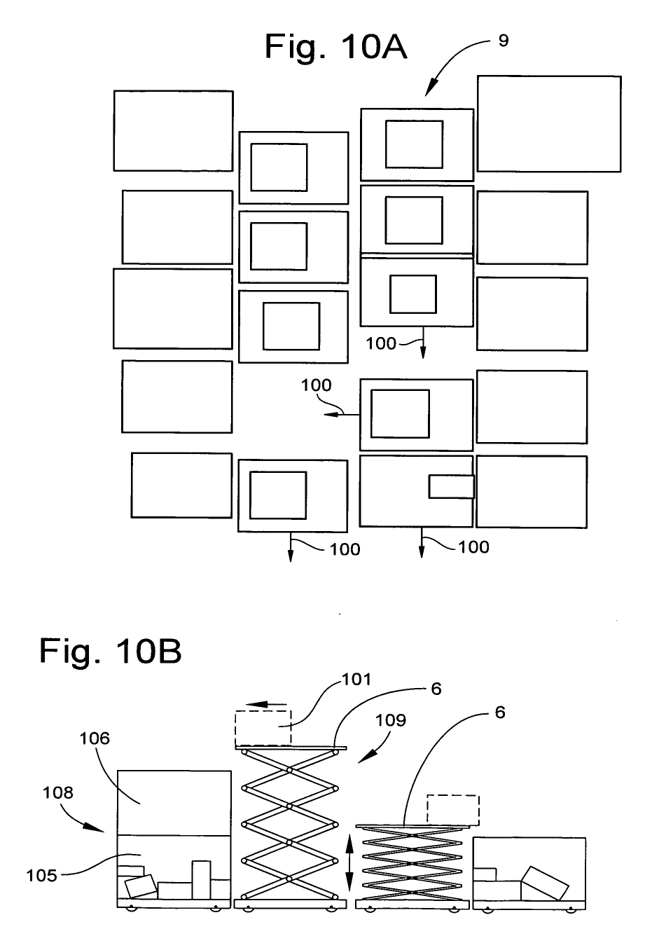

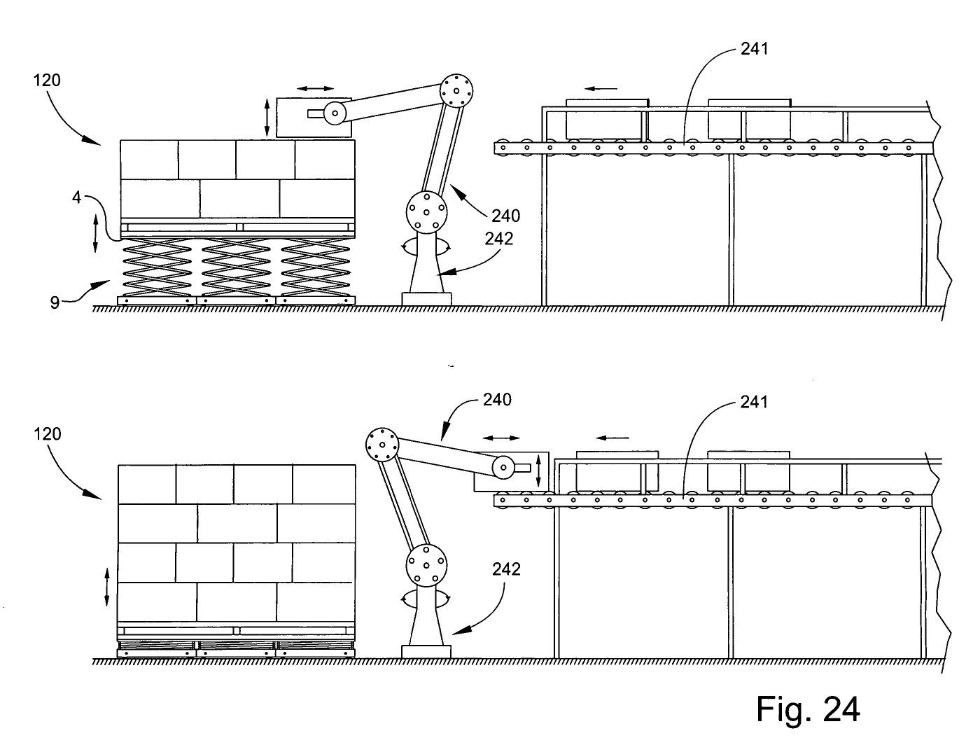

The goods supporting platform 4 can be a device that holds goods 5 and is able to (or alternatively, unable to) move the goods 5 laterally off the shuttle (see FIG. 1B and 1D). For example, the goods supporting platform 4 can be a device that will allow the goods to be transported laterally off the shuttle 9, such as a cross belt adaptor 6, which is not readily visible in FIG. 1D (but can be better seen in for example, FIGS. 7 and 10). It is contemplated and within the scope of the present invention to adapt other means of transporting goods laterally with the goods supporting platform 4 (e.g., cross belt design regular belt with a motor attached that can go left or right, a loose item option top loader, or a tote handling device, or a picking dispenser device). The goods supporting platform 4 and the lift supporting platform 2 can be made of any of a plurality of materials, including but not limited to metals, natural or synthetic polymeric materials, rubbers, or any other natural or synthetic materials that have the structural integrity to support the components and/or goods to be transported. The platforms are shown in the later described figures as solid platforms with no holes. However, it is contemplated and within the scope of the invention that the goods supporting platform 4 and the lift supporting platform 2 can be a mesh or in any other form, which allows the respective platforms to serve their desired function, such as holding goods 5 for their transport. Moreover it is contemplated that any of many attachments can be placed on top of the goods supporting platform 4 or alternatively, can be used as replacements for the goods supporting platform 4. Possible attachments include a belt crossbelt, a handling unit device, a suction cup device for loading or unloading pallets, a loading and unloading device (for example, the palletizing robot arm 240 of FIG. 24 can be made smaller so that it can be adapted to pick up goods 5 and place them on the shuttle 9 or on a second shuttle) and the like. The attachments can be attached to the shuttles at any location in a warehouse. It is contemplated that one such place in a warehouse where attachments can be attached include a docking station.

In FIG. 1A and 1B, the shuttle is shown with a scissors lift 3. The scissors lift 3 is motorized to allow it to expand and collapse. The scissors lift 3 also has sufficient structure so that it can support the weight of the intended goods 5 to be transported. Although FIGS. 1A and 1B show a scissors lift 3, it is contemplated and within the scope of the instant invention that other means of lifting the goods supporting platform 4 can be used, such as hydraulic lifts, or other means that are well known by those of skill in the art. The shuttle 9 in the shown embodiment has four wheels 1 (see FIG. 1 C), however, it is contemplated and within the scope of the invention that the shuttle can have other numbers of wheels, with 4 or more wheels being preferred. The wheels are attached to a swivel mechanism (not shown) so that the shuttle can transport goods in any direction.

The shuttle may have an RF-ID chip (radio-frequency identification chip) attached to the shuttle (not shown in the figure) that allows an operator, a computer program, or a remote controller to be able to transmit and/or receive signals to/from the RF-ID chip, which instructs the shuttle 9 (with or without goods) to go to a certain location. The shuttle has a positioning system that allows one to identify the position of the shuttle, and the shuttle is able to respond to signals to transport itself with or without goods to a given location. Global positioning systems (GPS) are well known to those of skill in the art, such as the global positioning system that appears in U.S. Pat. No. 6,657,586 to Turner, which is hereby incorporated by reference in its entirety. Alternatively, systems that are similar to U.S. Pat. No. 6,657,586 to Turner (and that are well known to those of skill in the art) can be used in the instant invention. When multiple shuttles are employed, being able to ascertain the position of all of the shuttles (via a GPS-like system) allows a shuttle that is in close proximity to be used for a desired task. By using the shuttle that is in close proximity to perform the desired task, all tasks can be performed more rapidly and efficiently, which ultimately leads to higher output and/or reduced costs. Moreover, the use of multiple shuttles allows a freely configurable traffic flow, meaning the transportation system does not suffer from the bottleneck effects seen when employing conventional conveyor or picking systems.

Moreover, the shuttle has a motor (not shown) that is operatively connected to the wheels 1 and allows the shuttle to move and to stop (i.e., brake). Motors are also well known to those of skill in the art. The motor can be an electric motor, a gas powered motor, or a motor that uses some other source of energy, including but not limited to fuel cell powered motors, battery powered motors, solar powered motors, and the like. In addition to performing the function of transporting the shuttle, the shuttle transporting motor (or alternatively, one or more separate motors) may perform functions such as operating the lift, picking up or deposing goods, or the like.

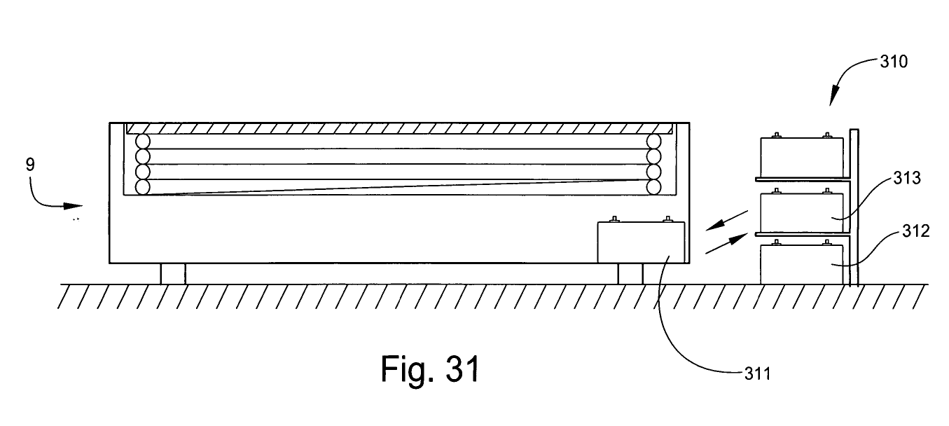

If a battery powered motor is used, it is contemplated and within the scope of the invention that a means of charging the battery may be employed wherein a charger is integrated into a travel path of the shuttle. Thus, every time that a shuttle goes by a certain location, the battery gets automatically charged. This obviates the need to charge the batteries by other means (such as by plugging the shuttles into an electrical outlet). In another embodiment, one can charge the batteries by connecting the batteries to a source of electricity that charges the shuttles (such as an electrical outlet and a power line). Another embodiment that allows charging of batteries would be by using a permanent magnet alternator system such as the system employed in U.S. Pat. No. 6,181,111 to Hoffman, which is hereby incorporated in its entirety by reference. It is also contemplated and within the scope of the invention to exchange batteries (see FIG. 31, for example).

Another means of charging a battery powered motor that may be used with the instant invention is charging the batteries through the braking of the wheels 1. The heat generated can be converted into electrical energy, which in turn can be used to recharge the batteries. This is a technology that is known by those of skill in the art and is employed in certain hybrid automobiles that are in conventional use today (for an example of this technology see U.S. Pat. No. 6,543,565 to Phillips, which is hereby incorporated in its entirety by reference).

In an embodiment, the shuttles may have a device on them that measures the power reserves left in the battery, and once the power reserves goes below a threshold level, the shuttle is instructed to (for example by a computer program) to move to a location wherein the batteries are exchanged automatically (for example as shown in FIG. 31).

The shuttles 9 of the instant invention may be allowed to roam freely. In this embodiment, no switches would be needed to turn on and off a shuttle. The shuttles would be permanently on. However, it is contemplated and within the scope of the instant invention that a switch can be associated with each shuttle (or alternatively, a remote switch that controls each of the shuttles, or as another alternative, an universal remote switch that controls all of the shuttles) that allows one to turn off the shuttle(s).

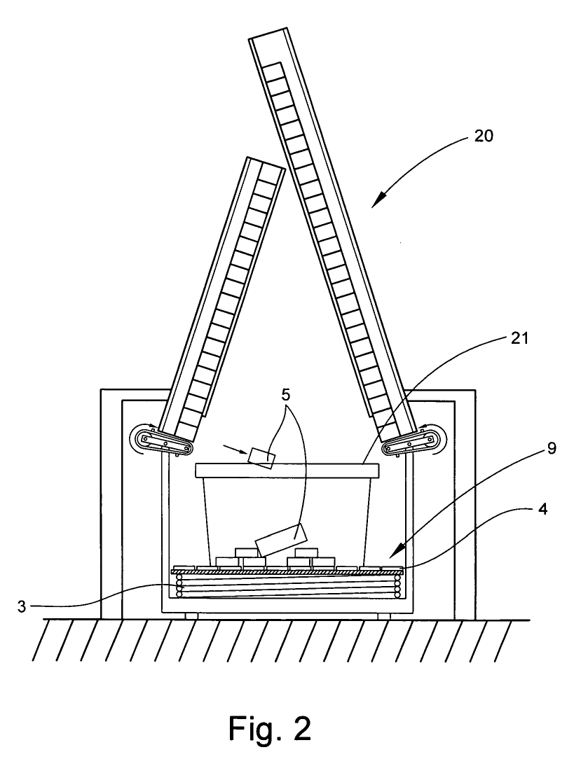

FIG. 2 shows a shuttle 9, which is below an A-frame like structure 20 wherein the shuttle is dispensing goods 5 into a container 21 that may or may not contain other goods 5. In this figure, the shuttle scissors lift 3 is in the collapsed position so that the goods supporting platform 4 is close in vicinity to the scissors lift supporting platform. By employing shuttles that are sent to the correct A-frame 20 position, the shuttles themselves perform the picking function that has traditionally been done by conventional auto-picking systems, such as using an A-frame, MRS Picking Robots, TD-Lean systems, or other systems known to those of skill in the art. The shuttle 9 may also contain various attachments, for example, the shuttle 9 may contain a dispenser on the shuttle (or multiple dispensers on the shuttle).

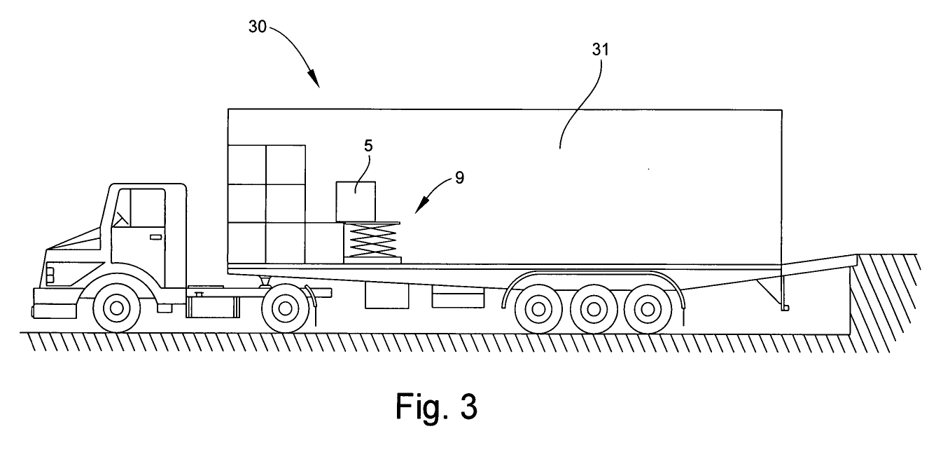

FIG. 3 shows the shuttle 9 in the trailer 31 of a tractor trailer 30 with goods 5 being loaded into or unloaded from the trailer 31. Because the shuttles 9 are able to travel the unloading and loading of tractor trailers, ships, trains, and other vehicles can be performed automatically by using pre-programmed algorithms or interactively programmed algorithms to load/unload vehicles with minimal human labor (for example, the shuttles 9 can be used during the graveyard shift of a day when there are fewer employees around). It is contemplated and within the scope of the invention that shuttles can be combined with a conveyor system to load or unload vehicles.

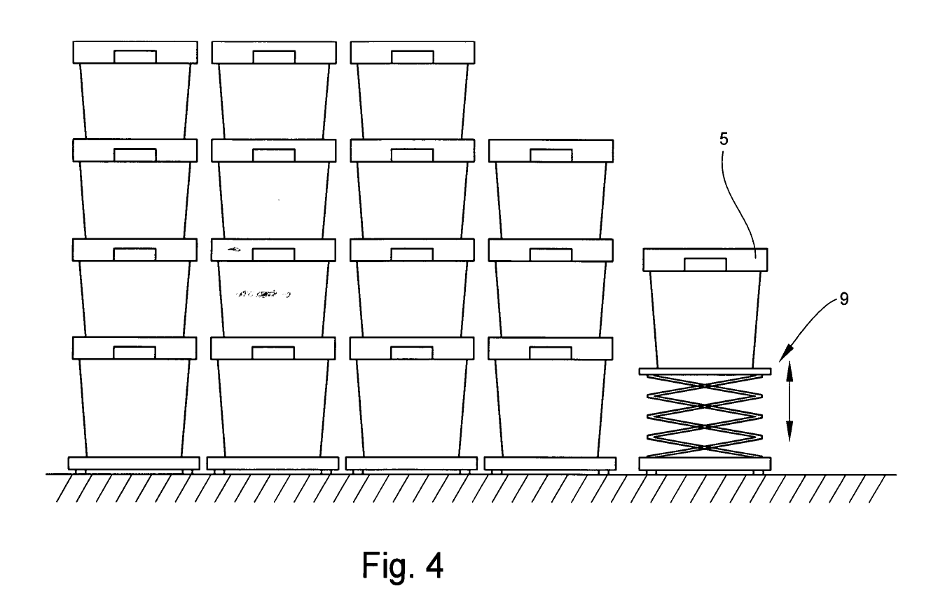

FIG. 4 shows goods 5 on a series of shuttles 9. In this embodiment, the containers at the bottom (touching the shuttles) tend to be heavier than each of the respective containers as they move away from the bottom container with the lighter containers being at the top. In this embodiment, the containers can be positioned in a way that allows a pallet to be created wherein the containers in the pallet can be logically removed. For example, by mapping retail shelf so it is floor ready (i.e., mapping out the desired location where a given container is to be positioned when removed from a pallet), one can determine the position where the container should be placed when creating the pallet. As an example, if one has mapped retail shelf, a light container that is at the top of the pallet can be deposited at a given location (i.e., sequence the goods so they are removed close to the shelf where it will be placed). The removal of this light container exposes a container below it that is the next container to be removed at a proximate location. By positioning the containers in the appropriate position, the time required for transporting goods to a desired location in a store can be minimized, human labor can be reduced, and mistakes minimized.

Conventionally, the mapping of a store has been done manually, and the positional placement of containers in a pallet also conventionally has been done manually. It is contemplated and within the scope of the instant invention to map the store using an algorithm and/or computer program, which can be input into one or a plurality of shuttles that will allow the containers to be positioned in the pallet for optimal removal of those containers in the store. It is also contemplated that shuttles can travel with the trucks (i.e., tractor trailers) to the retail stores to perform shelf replenishment tasks.

Likewise, the shuttles of the instant invention possess the ability to stack multiple totes (or other forms of cartons and/or containers) on top of each other wherein they can be transported by another one or plurality of shuttles.

One or more shuttles can be used to position containers on the interconnected shuttles where the pallet resides. Because the shuttles are able to move in a plurality of directions, goods that are to be added to a pallet can be placed at any position in the pallet. For example, good A can be placed on one side of a pallet and good B placed on the other side. Good C can then be placed on top of good A or on top of good B, or alternatively, placed adjacent to good A or good B. By logically positioning each of goods A, B, and C and additional goods D, E, etc., one can generate a pallet that allows the goods to be effectively removed such as to minimize the time required for deposing goods to a desired location in a store, reduce human labor, and minimize mistakes.

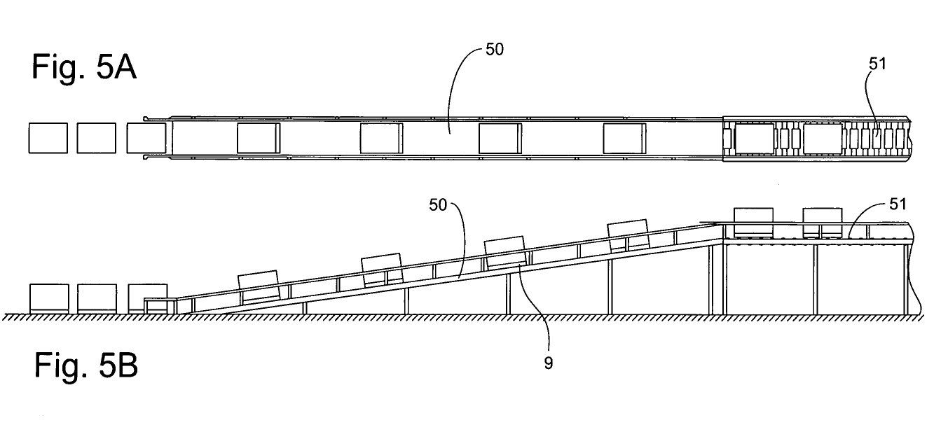

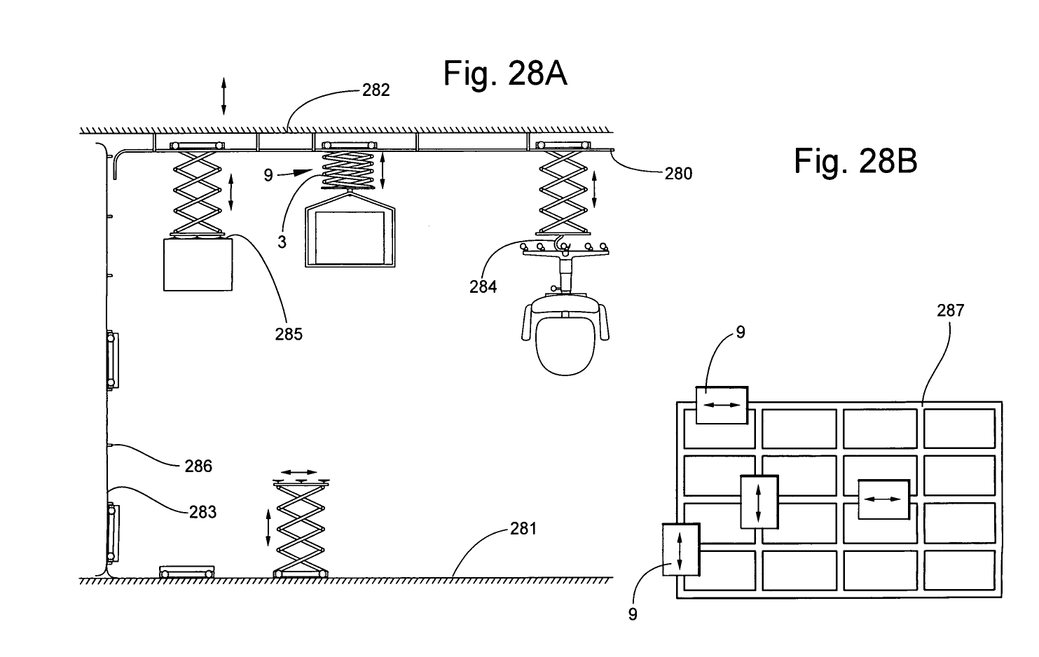

FIGS. 5A and 5B show a top down view and a side view of a ramp 50, respectively for the shuttles 9 that will allow the shuttles to be transported to a given location that is higher or lower than from where the shuttle originated. In FIGS. 5A and 5B, the shuttles are combined with a conveyor system 51 that can increase the velocity with which the shuttle 9 moves (i.e., the shuttles' velocity is combined with the velocity of the conveyor 51). Alternatively, the shuttles 9 may remain stationary on the conveyor 51 wherein the velocity of the shuttle is determined by the velocity of the conveyor. Although the incline of the conveyor is shown in FIGS. 5A and 5B as being 8%, it should be understood that any pitch/slope is contemplated (including moving the shuttles vertically). When a vertical conveyor or a relatively steep conveyor is used, it is contemplated that a device may be present on either the conveyor 51 or on the shuttle 9 that keeps the shuttle 9 from slippage on the conveyor. For example, a hook 284 may be used to engage the shuttle and/or goods and keep the shuttle and/or goods from moving while on the conveyor (see FIG. 28). In one embodiment, the use of a vertical conveyor 283 is preferred as it leads to a conservation in the amount of space that is used, for example, in a warehouse. A vertical conveyor may use a pin 286 to engage the shuttle 9 (see FIG. 28). A vertical conveyor 283 is likely to be quite useful in many industries, for example, in the garment industry. It is also contemplated and within the scope of the instant invention for the shuttle to unload goods directly on to the conveyor for movement of those goods by the conveyor without the presence of the shuttle. Shuttles at the end of the conveyor can then unload the goods from the conveyor.

In an embodiment, the conveyor 51 may be present at the end of a ramp 50 (i.e., in a flat portion). Shuttles may transport goods up the ramp. When the goods are heavy, more than one shuttle may be used to transport goods, including shuttles that may by used to push or pull the shuttle as it goes up a ramp (or alternatively, shuttles may be used to protect and or slow a shuttle or shuttles from the inertia of downward movement by descending a ramp).

In another embodiment, shuttles 9 may be transported by inverting them. The shuttles while being inverted and when inverted can transport goods. One means of inverting the shuttle is by travel on a rail 280 which transports the shuttles from the floor 281 to the roof 282 (see FIG. 28). This may be important in many industries, such as in the automotive industry where a heavy part can easily be positioned to a given location by transporting it on the ceiling.

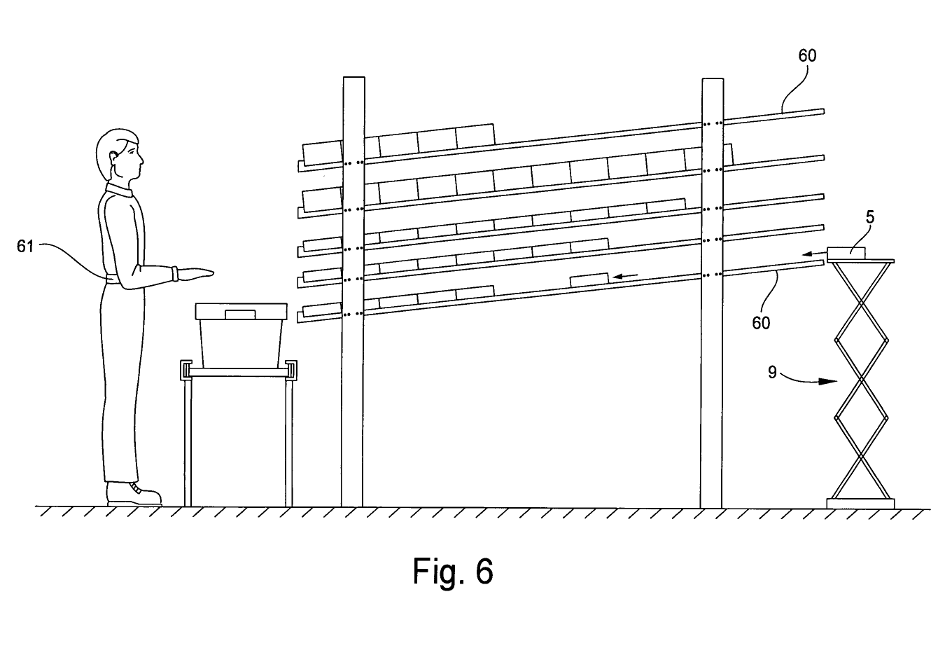

FIG. 6 shows a shuttle 9 (on the right hand side of the figure) that is depositing goods onto a roller conveyor chute 60. By employing more than one shuttle and a series of roller conveyor chutes 60, parallel picking of the goods can occur readily and does not require the manual labor wherein a person brings a carton to the roller conveyor chutes 60. This allows for a cheaper, faster and more efficient way of picking goods to be transported to an alternative location than the conventional means of picking goods, which is typically done using forklifts, conveyors and/or manually. In the figure, a person 61 may (or may not) be present to verify that the goods are being accurately picked. Alternatively, that individual 61 may be present to take merchandise out of a carton and place merchandise in a tote or to perform some other function with the goods, such as the art recognized picking the goods to light.

FIG. 7 shows an embodiment wherein goods 5 can be delivered by the use of chutes 60 that are arranged in a parallel horizontal position and/or at different heights. In this embodiment the goods can be delivered to the chutes by use of a cross belt adapter 6 (on the shuttle), which will allow the goods to be transported laterally from the shuttle to the chute 60 where it is to be delivered. The system as shown in FIG. 7 allows for goods 5 to be processed in parallel so that many different shuttles can deliver goods to a desired location. Moreover, the shuttles 9 can rise up to any level to deposit the goods 5 into the desired chute 60. Thus, this system allows delivery of goods not only in dimensions parallel to the floor but also allows delivery of goods at different heights (as shown in the figure). In this three-dimensional processing of goods, goods can be (delivered) sorted by a plurality of shuttles and the delivery time is substantially expedited relative to the goods delivery methods that are in conventional use today such as the race track design sorter wherein an endless train is only at one level with exits and chutes to a sort destination.

Traditionally, sorting has involved three main steps; 1) a manual batch picking step, 2) delivery of the batch picked items to the sorter induction (a step wherein the goods are brought to an induction station) and 3) an induction into the sortation system. The picking step traditionally has been done with manual labor and tends to be very expensive (because of the time that it takes and the manual labor that is required). The instant invention (as shown in FIGS. 7, 10, and 11) is advantageous in that the picking step and bringing the goods to the induction station steps are no longer done by human labor (but rather are performed by the shuttles).

The shuttles 9 are able to do the batch picking step and bring the goods to the induction station. Once an order is placed, the shuttles are sent (via a computer program, which is either preprogrammed or interactively programmed) to go retrieve goods 5 and bring them to the induction station.

The shuttles can recognize the required goods 5 by an RF ID reader that reads a RF-ID chip or barcode on the goods. After reading the correct goods associated with the desired RF-ID, the goods 5 are retrieved by the shuttle 9 and delivered to the induction station for induction into a sorter. The use of the shuttles will dramatically reduce the amount of people needed to bring the correct goods to the induction station. The shuttles can be used for a batch pick function, a delivery to sorter induction and to the sortation process itself. Moreover, the shuttles can be used for the taking away of finished sorted items. Another function that the shuttles can perform is to read re-induction or overflow functions to accommodate different sort strategies.

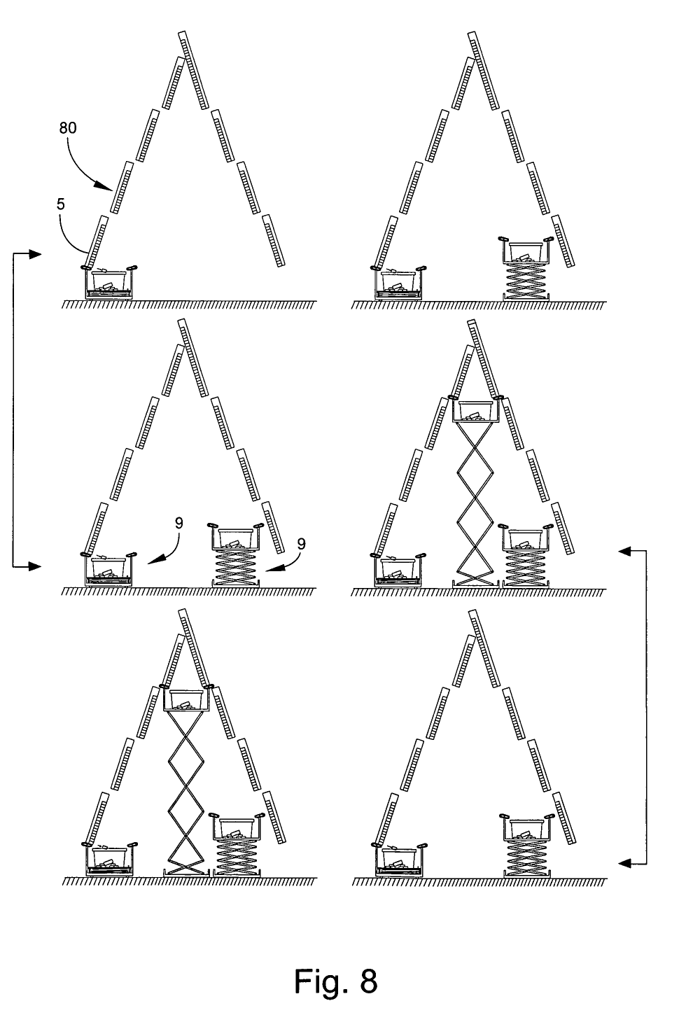

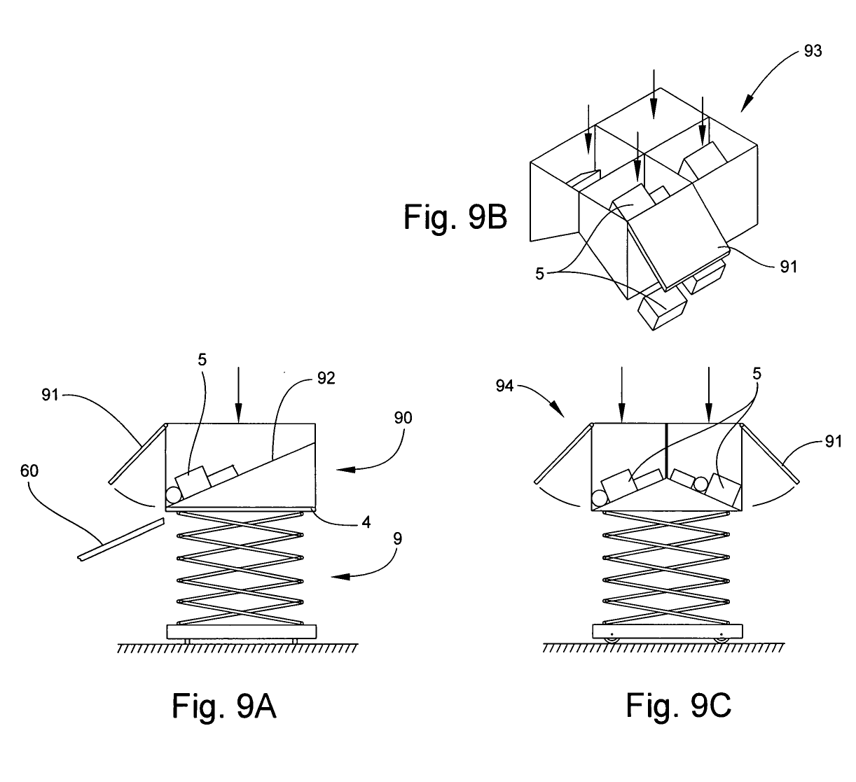

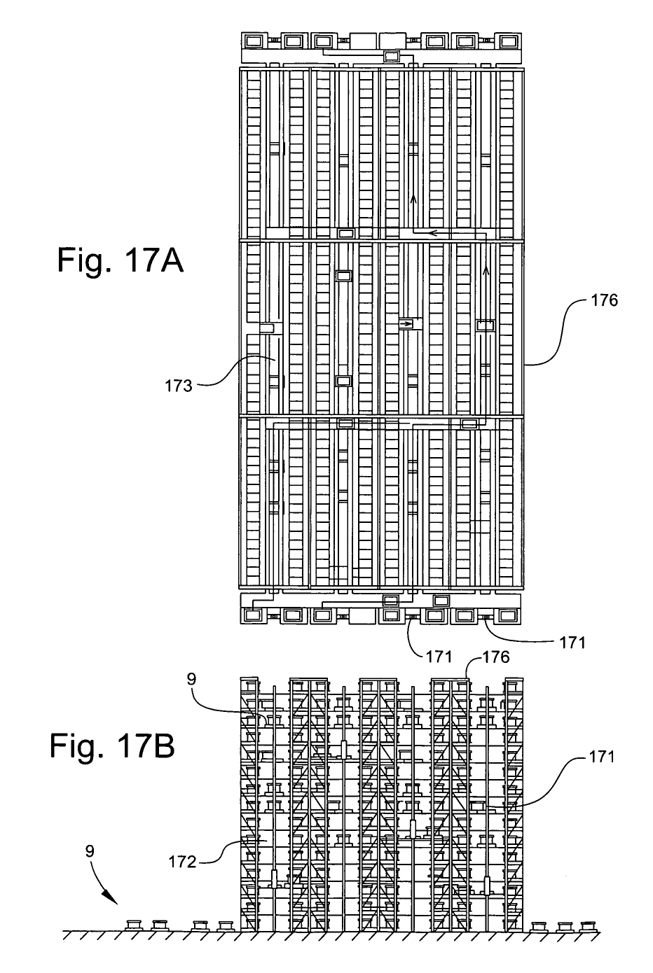

FIG. 8 shows a shuttle that is picking (or delivering) goods 5 from channels 80. Multiple shuttles 9 can be used in this embodiment to pick/sort goods in parallel. On the shuttle, one can place an attachable dispenser, which is more fully explained and better shown in FIG. 9. The attachable dispenser can be made of any material, such as metal, a polymeric material (such as plastics or rubbers) or any other natural or synthetic material that has the structural integrity to support goods. One can have multiple levels of the channels so that the shuttles can pick or deliver goods (shown by the double-headed arrows on each of the sides of the figure). In FIG. 8, three different levels of channels are shown (two at the uppermost level, two at a mid level and two at the lowest level). A continuous shuttle lift or some other means of moving shuttles vertically (see for example the shuttle lift 170 in FIGS. 17A and 177B) allows the shuttles 9 to move from one level to another level.

FIG. 9A shows a shuttle 9 that has an attachable dispenser 90, which can be placed on top of the goods supporting platform 4 (or alternatively replace the goods supporting platform 4) wherein said attachable dispenser 90 has a slanted bottom 92 and a side door 91. In this embodiment, the shuttle as appears in FIG. 1 can be modified simply by placing a desired attachable dispenser 90 on the shuttle (or the attachable dispenser 90 can be removed to generate the shuttle of FIG. 1). The slanted bottom 92 allows goods 5 to be delivered to a chute 60 or a tote or some other location when the side door 91 is open (as appears in FIGS. 9A, 9B, and 9C). The slanted bottom 92 allows goods to slide out of the shuttle (using gravity) when the side door 91 is opened. The side door 91 has a means that prevents the door from opening unless it is in the correct desired location. One such means might be an RF chip that is programmable and is programmed to open the side door 91 releasing the goods 5 once it makes contact (or in close enough proximity) with a signal or receiver of a signal at a given location. Alternatively, the shuttle 9 can be programmed to open the side door 91 once it has reached a given location by a global positioning system. In FIG. 9A, the goods go down a chute 60 and/or into a tote.

Another attachable dispenser can replace the attachable dispenser that is currently shown with the shuttle in FIG. 9A. One exemplary embodiment of this replacement attachable dispenser is shown in FIG. 9B, wherein the attachable dispenser contains a quadruple version of the attachable dispenser 93 so that a shuttle can transport different types of goods 5 to a given location. Once that given location is reached, a side door 91 will open that dispenses only the goods that are to be delivered to that location. The shuttle can then subsequently transport the next goods to the next location wherein another side door is opened to deposit different goods from a different compartment of the attachable dispenser at that subsequent location. It is contemplated and within the scope of the instant invention to have any number of compartments in the attachable dispenser 90 and 93 (for example, 2, 3 or 4 compartments or more). FIG. 9C shows a two compartment attachable dispenser 94. Alternatively, it is also contemplated and within the scope of the invention to have other means of dispensing goods from an attachable dispenser to a given location (including but not limited to a bottom door or another device that is designed to release the goods once a given location is reached).

In an exemplary means of opening the side door 91, it is contemplated that a lock (not shown) may keep the side or bottom door shut until a desired location is reached whereupon the lock is opened so that the gravity of the goods pushes the side door 91 open allowing the goods 5 to be delivered to the desired location. Alternatively, the side door 91 may be sufficiently heavy so that no good are released until a signal is received, whereupon receipt of the signal activates the doors to be opened along a tract-like mechanism by the use of a motor.

In another exemplary embodiment, the attachable dispenser may not have a slanted bottom 92 in the compartment, but may rather have a belt transfer table option with a side opening door. When a shuttle arrives at a given location, a signal is sent or received that the belt transfer table is to be turned on. When the belt transfer table is turned on, the goods will then pass through a side door and be delivered to the desired location.

The attachable dispenser, in one embodiment, can be combined with an A-frame (see 20 in FIG. 2) so that the A-frame deposits orders into the attachable dispenser allowing the consolidation of orders. The shuttle can go to different A-frames that are loaded with different goods getting the required goods at each of the respective A-frames. This methodology allows the shuttles (when receiving goods from an A-frame) to process partial orders effectively. In contrast, partial orders in the conventional art generally tend to be problematic. As an example, if an order comes in wherein the order places an order for products A and B, the conventional method will pack a tote (using conveyors or human labor) to pack A and B together. Subsequently, if the order is expanded to order item C, which is to be packed with the tote containing A and B, filling this order is problematic. Generally, it requires human labor to retrieve item C to make sure that it gets included with items A and B. In contrast, in the above situation, the shuttle can go and retrieve the subsequently ordered item C. If item C is associated with an A-frame 20, the shuttle can go to the A-frame to retrieve item C. Thus, the shuttle system is much more effective at order consolidation than conventional methods.

In one embodiment, it is contemplated that the shuttles can be used for feeding different packaging devices. However, although the shuttles can consolidate orders, it is contemplated and within the scope of the invention that portions of an order may be packed automatically while other portions of an order may require manual packing or labeling.

Likewise, retrieving multiple items and consolidating orders from partial orders is facilitated by employing the sorting as appears in FIGS. 10A and 10B. FIGS. 10A and 10B show two different perspective views of sorting cartons and totes or products. FIG. 10A shows a top down view of a plurality of shuttles 9 in close proximity to each other that allows the sortation of goods directly to cartons and/or totes rather than using chutes. It is important to note that the sort sequences can also be changed by the shuttles freely configurable travel path 100. FIG. 10B shows the transfer of cartons and/or small totes 101 from one shuttle 109 to another shuttle 108. The shuttles in FIGS. 10A and 10B have an RF-ID chip, which allows the communication of one shuttle with another (the other shuttle may have an RF-ID reader or a bar-code reader that allows one shuttle to identify the other shuttle from which it is to transport or receive goods). One means of transferring the totes from one shuttle to another is by use of a cross belt adapter 6 (not shown in detail). The cross belt adapter 6 is instructed to turn on when the signaling shuttle 109 recognizes that it is adjacent to the receiving shuttle 108. Thus, the tote 101 is transported laterally from one shuttle 109 to the receiving shuttle 108. In this manner, a small tote 101 (or a bigger tote) that is to be sent to a certain location can be packaged with the correct order and sent to the desired location. Thus, one shuttle can receive totes/products from a series of other shuttles with the appropriate goods from a plurality of shuttles, allowing the receiving shuttle 108 to complete a customer order (or alternatively, to transport a given plurality of goods to a given location). In this manner, the shuttles can be used to sort goods. The goods can be sorted by size, route, zip code, product category, store country, or by some other factor using this methodology.

An algorithm or computer program can be used to instruct a shuttle to transfer totes/products to another shuttle. As an alternative to using a pre-programmed algorithm, it is contemplated and within the scope of the invention to use interactive instructions wherein an operator interactively (and optionally, remotely) instructs the shuttle to transfer its tote to the other shuttle. The left most side of FIG. 10B shows a receiving shuttle 108 that has one larger tote 105 on the bottom and an equally large tote 106 that is empty on the top. This part of the figure shows that the shuttles may be able to sort and/or transport any of a plurality of totes to any desired location.

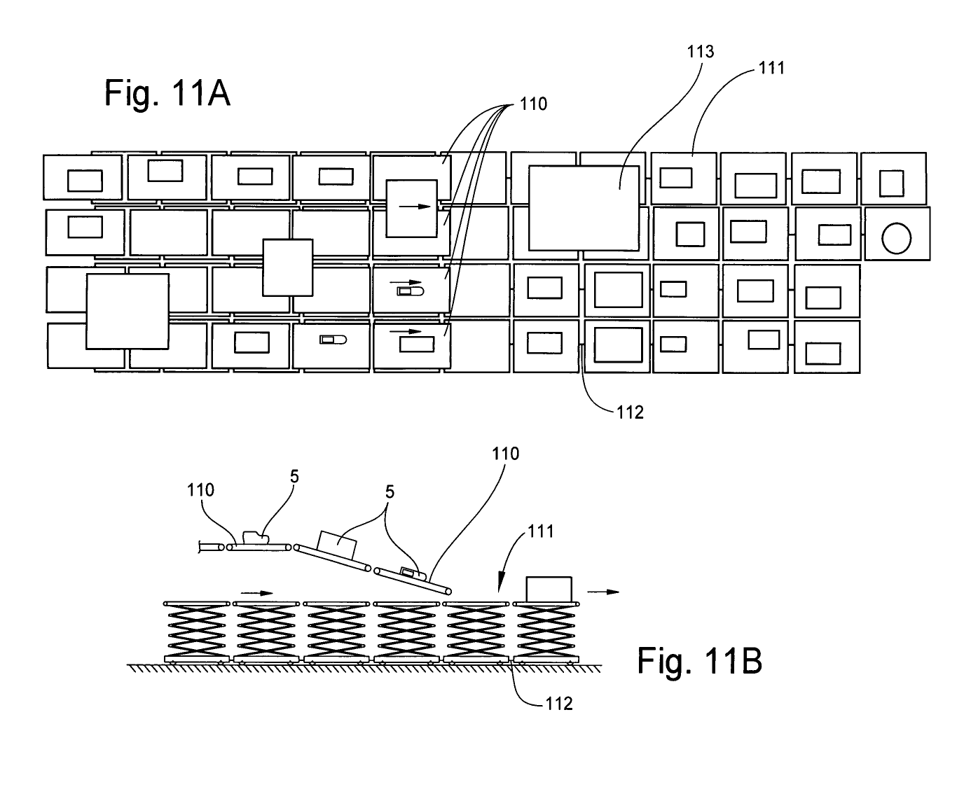

FIGS. 11 A and 11B show multiple parallel top-loader induction belts 110 onto sort shuttles 111, which are below the multiple parallel top-loader induction belts 110. FIG. 11A shows a top down depiction and FIG. 11B shows a depiction from the side. In both figures, the shuttles travel together in a train-like formation to load the shuttles consistently from the top (so that the correct shuttle is placed under the top loader sorter when the desired goods are being deposited in the shuttle.) The shuttles 111 may be connected to each other by a connector 112 as shown in FIGS. 11 A and 11B or alternatively, the shuttles may not be connected to each other. The goods 5 may have an RF chip or barcode associated with them to marry the item to the receiving shuttle. It is contemplated and within the scope of the invention to have a variety of top-loader sorters working in parallel so that goods can be delivered to a plurality of different shuttles simultaneously (as shown in FIG. 11 A). Having multiple top-loader feeders operating in parallel allows for very high induction speeds in a relatively small space. This arrangement ultimately means higher production and/or lower costs.

In an embodiment, and as seen in FIG. 11A, the shuttles can run in parallel formation. In this embodiment, the shuttles can be positioned adjacent to each other so that they can receive small packages in an individual shuttle, or if the package is large, multiple shuttles can receive a big package 113. Thus, the advantage of this sorting system is that a variety of different package sizes can be sorted simultaneously and the induction as well as the sorter shuttles adapt automatically to the package's size. Products can also be transferred dynamically vertically across multiple shuttles to change sortation exits. Shuttles can change lanes, exit lanes and bypass other shuttles to allow for last minute sort destination changes. This ability of the shuttles to undergo these functions may be important in situations wherein chute (see chute 60 in FIG. 6) sorting has reached its limit (and is unable to accommodate further capacity), a customer has changed an order after a sort process has already started, during an express order processing, etc. Although only a few inductions and shuttle sorter lanes are shown in the figure, it is contemplated and within the scope of the invention to encompass as many or as few inductions as is necessary to accomplish the sorting desired. The shuttles can join, be connected to each other by a connector 112 and can freely leave the sortation process and these shuttles are available for delivery to other processing areas such as the packing area or value added service workstations after the sorting by the shuttles (and not humans). This eliminates substantial manual work and multiple handling steps.

Shuttles can immediately be reused after discharging the item to be sorted to perform other tasks. For example: the shuttles can deliver empty cartons/totes to sort destinations, they can take away finished sorted cartons to shipping, they can stack full totes, they can bring partially sorted items back to re-induction, etc. All of these tasks are currently done manually due to the fact that the conventional race track sorter can't enter or leave the system. In the conventional system, after discharging an item to a chute a position on the track travels idle on the track until it returns to an induction where the position receives products again. This “idle operation mode” results in costly operational inefficiencies. Freely roaming sort shuttles do not suffer from this drawback as they can exit anytime and take the shortest route back to induction.

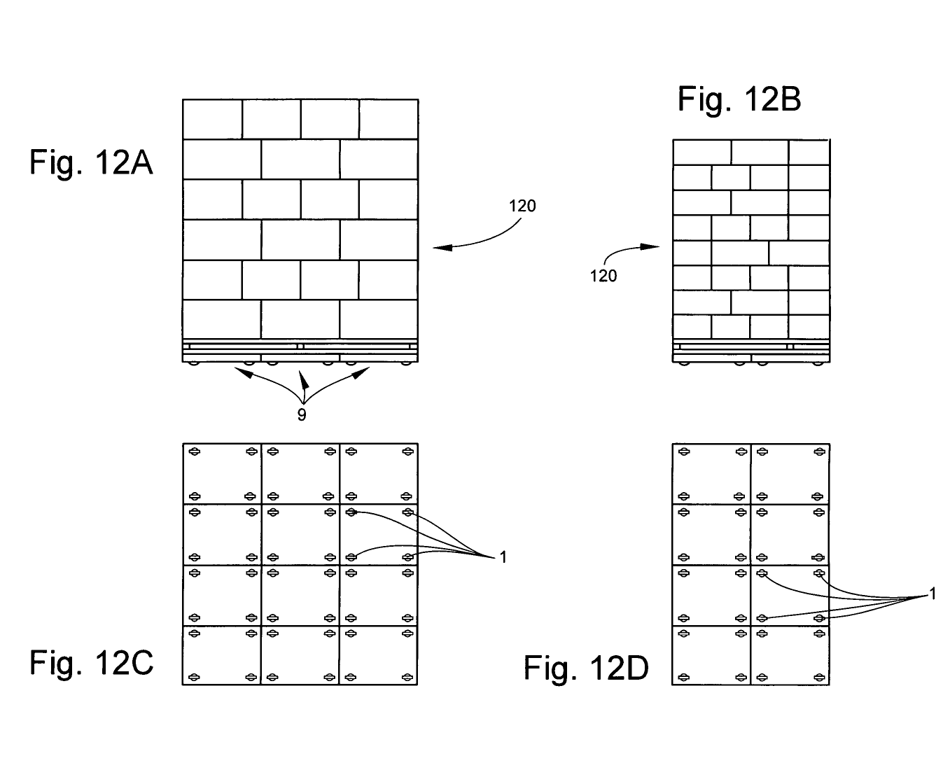

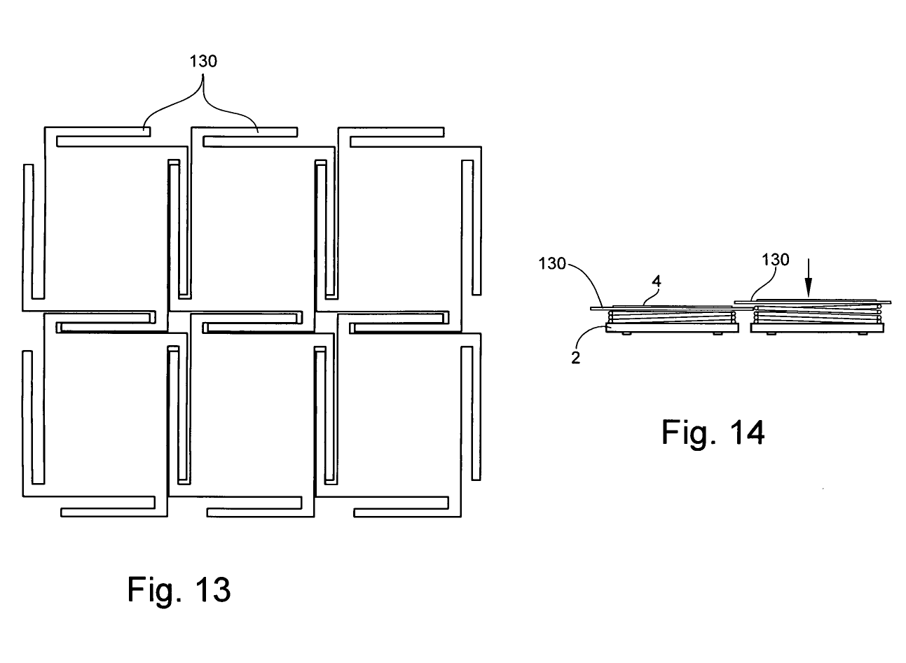

FIGS. 12A-D shows a series of shuttles, which are interlocked together to support a pallet 120. Because often times pallets 120 are heavy and rather voluminous, it may be necessary to interconnect several shuttles together to support the mass of the pallet as well as have sufficient surface area to accommodate the size of the pallet. The pallet 120 as shown in FIG. 12A may be between 1500-2000 pounds and the pallet 120 as shown in 12B may be between 1200-1600 pounds. Because each of the shuttles have multiple wheels (best shown in FIGS. 12C and 12D wherein each shuttle has four wheels, although other numbers of wheels are possible and contemplated as being within the scope of the present invention), the weight of the pallet can be distributed over the many wheels, meaning that no one point on the shuttle bears the full brunt of the weight. FIGS. 12A and 12B show pallets from the side supported on top of the shuttles. The bottom two drawings 12C and 12D show the interlocking shuttles from the bottom, with the wheels 1 being conspicuously present in these drawings.

If the pallet is heavy, and the interlocking shuttles have problems transporting the pallet, additional shuttles can be employed to push or pull the pallet. These shuttles can be pre-programmed to aid in transporting the heavy pallet that is on the interlocking shuttles, or alternatively, the shuttles can be interactively remotely programmed to be used as circumstances arise (in the instant case, to aid in transporting the heavy pallet). Likewise, additional shuttles can be transported to the needed site and used when goods are transported up ramps (that require the use of additional power to go up the ramp).

It is contemplated and within the scope of the invention that the interlocking mechanism and its subsequent unlocking may occur automatically as needed. A remote operator may input a computer program or an algorithm into a computer that is able to communicate with RF-ID chips on the shuttles that instruct the shuttles to go to a certain location to interlock with other shuttles (or similarly, to unlock from a group of interlocked shuttles). The shuttles ability to ascertain their positions and to communicate with each other may allow them to interlock.

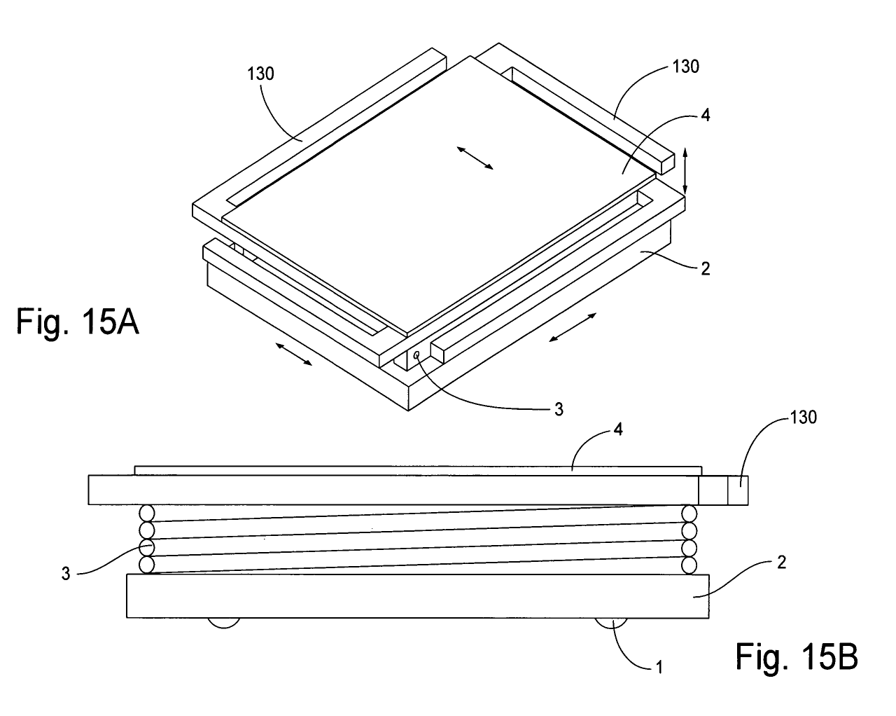

FIGS. 13, 14, and 15 show one method by which the shuttles interlock in order to support pallets. It should be recognized that any of a plurality of interconnecting the shuttles can occur, for example, by using magnetism or alternatively, can be interconnected by using an interlocking mechanism or a combination of the two. In FIGS. 13, 14, 15A and 15B, it is shown how arms that are present on the shuttles may allow them to interlock. FIG. 13 shows a series of six shuttles which are interlocked together. The arms 130 may be present adjacent to the goods supporting platform 4 as shown in FIGS. 14, or alternatively, slightly below the goods supporting platform 4 (but above the scissors lift 3) as shown in FIGS. 15A (perspective view) and 15B (side view). The scissors lift 3 may lift the goods supporting platform 4 up and/or down to position the arms 130 so that they can interlock (after the shuttles are in close proximity to each other). Alternatively, if the arms 130 are slightly below the goods supporting platform 4 but above the scissors lift 3 the scissors lift 3 can still be used to position the interlocking arms 130 so that they interlock (once the shuttles are in sufficiently close proximity to each other).

In another embodiment, the invention may have the interlocking arms on the scissor lift supporting platform 2. In order to get the arms to interlock, the arms 130 on different sides of the shuttles may be at different levels on different sides of the shuttles so the shuttle arms 130 would be able to interlock. This configuration would likely require that the shuttles to be oriented in a certain direction in order to have the arms interlock. Thus, the preferred design is to have the shuttle arms present above the scissors lift 3.

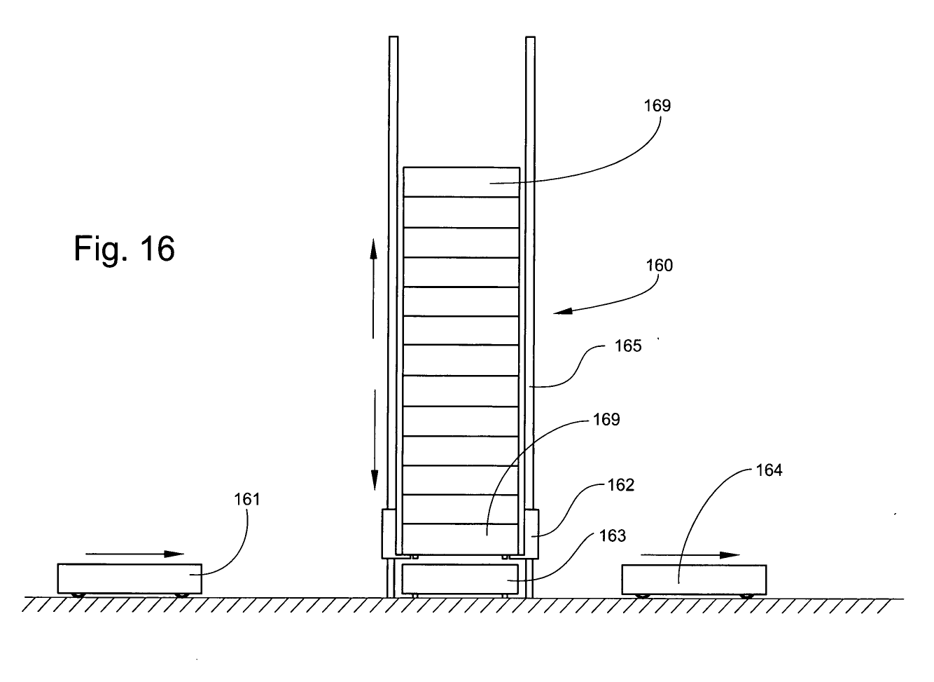

FIG. 16 shows a stacker 160 wherein unused shuttles 169 can be stored. In this figure, the shuttle 161 is sent by remote instruction to arrive at the bottom of the shuttle stacker. Two L-shaped lifts 162 are present on each side of the stacker near the bottom of the stacker. These L-shaped lifts 162 are designed so that they can go up and down and will fit under each side of the shuttle 169. The lifts are designed so that they can rotate to fit under the scissors lift supporting platform 2 (not shown in detail in FIG. 16) so that the shuttles can be lifted. In FIG. 16, a shuttle 163 can be seen at the bottom of the stacker 160 that has not yet been lifted. Thirteen shuttles 169 are in the stacker with one shuttle 163 below these thirteen lifted (and stored) shuttles. The stacker stores shuttles until they are needed, whereupon a shuttle is released and sent by remote instruction to go to the location where the shuttle 164 is needed. This is accomplished by the lifts lowering a shuttle until it touches the floor, whereupon the lift releases the shuttle so that it can be sent to the desired location to transport goods. The use of a stacker 160 is an efficient use of space as the shuttles 169 are stacked vertically. Thus, space that is often wasted in conventional venues (such as warehouses) can be effectively used by the stacker 160 as shown.

A stacker 160 also optionally contains a means of charging the motor of the shuttle while being stored. In the walls 165 of the stacker 160, it is contemplated and within the scope of the instant invention that a charger may be present that automatically charges the motor (for example, a battery powered motor) during storage. The shuttle motor may be configured so that it makes contact with an electrical outlet that is in the stacker walls 165, thereby effectively charging the motor battery. Accordingly, when the shuttle 164 is instructed to perform a task after having been stored in a stacker, the motor is adequately recharged so that it can perform the desired task.

FIGS. 17A and 17B show another means of an automatic storing retrieval system (AS/RS) for storing and or retrieving shuttles and/or goods. FIGS. 17A and 17B show modular racks 175 wherein shuttles, totes, pallets or horizontal trains can be stored.

FIG. 17B shows the front view of these modular racks 175 and FIG. 17A shows a top view of these modular racks. As many or as few of the modular racks 175 can be used. These modular racks 175 are particularly useful when space is limited (such as if used in a warehouse that is present in an inner city) as the modular racks 175 efficiently use vertical space. The shuttles 9 can roam freely from floor to floor in the modular racks and can go from side to side. Because the shuttles possess scissors lifts 3, it is not necessary that the shuttles 9 be able to go to each of the floors to store goods, such as totes, pallets or other cargo. The scissors lifts 3 can go up or down to put goods in the correct proximity for storage on a given floor, then the use of a device such as a cross belt or some other means of moving goods laterally off the shuttles can deliver/store goods at that given floor. Alternatively, the goods can be stored on the shuttles on a given floor. There are vertical passageways 171 that allow the shuttles to go up and down to different floors (a similar device to the lifts that are used with the stacker of FIG. 16 can be used in this embodiment to transport the shuttles from floor to floor, although it should be understood that other means of transporting the shuttles to different floors are contemplated and within the scope of the instant invention). There are also horizontal passageways 172 that allow the shuttles to move horizontally from back to front of the modular racks 175 or horizontally from side to side of the modular racks 175. The modular racks 175 can accommodate single passageways or when joined together to create a large series of racks that can have multiple passageways that allow the shuttles to move without being impeded by other shuttles on the same or on different floors. In this way, the shuttles undergo a freely configurable traffic flow without congestion.

In one embodiment of the invention, a shuttle may be present semi-permanently on each floor for storage or for transporting goods on that floor, or alternatively, for transporting goods to another floor. For example, by using the scissors lift 3 to allow goods to be placed on a higher floor, a shuttle can effectively place goods on a higher floor where there is no shuttle present. Additional shuttles can be added as needed on a given floor or removed as needed. The modular racks and the instant shuttle system allow for the storage of goods and shuttles in three dimensions. This is an efficient use of space.

The modular racks 175 of FIGS. 17A and 17B can be configured such that multiple shuttles in the same aisle can bypass each other. For example, if an emergency room at a hospital needs various goods in less than 30 minutes for trauma patients, the shuttles ability to bypass each other may be important. If the trauma goods are stored in the modular racks 175 in the warehouse, the shuttles are able to bypass each other in the same aisle or in lifts 170. This can be achieved by having multiple horizontal and vertical passageways or alternatively, a first shuttle can pass goods from the first shuttle to a second shuttle. The second shuttle can then transport the goods to the needed location. The modular racks 175 can also be configured so that shuttles are also able to bypass or skip different aisles.

The shuttle system of the instant invention is advantageous because of the shuttles ability to leave the modular rack system to go to different floors and/or different aisles and the ability to easily add and/or remove shuttles from a given level (including removing a shuttle from one level to place on another level).

The modular racks 175 in FIGS. 17A and 17B also may optionally have conveyors in them that can be turned on (perhaps by a remote signal given to a shuttle) to deliver the goods from the place where the goods are being stored on to the goods supporting platform 4 of the shuttle. Alternatively, the shuttles may have a means of picking up goods. The palletizing robot 240 of FIG. 24 may be miniaturized and placed on a goods supporting platform 4 of the shuttle to allow shuttles 9 to pick up goods. There are other means that goods can be picked up by shuttles such as the use of suction cups (see for example the suction cup or vacuum handling device 285 in FIG. 28) with robot arms, hooks, etc.

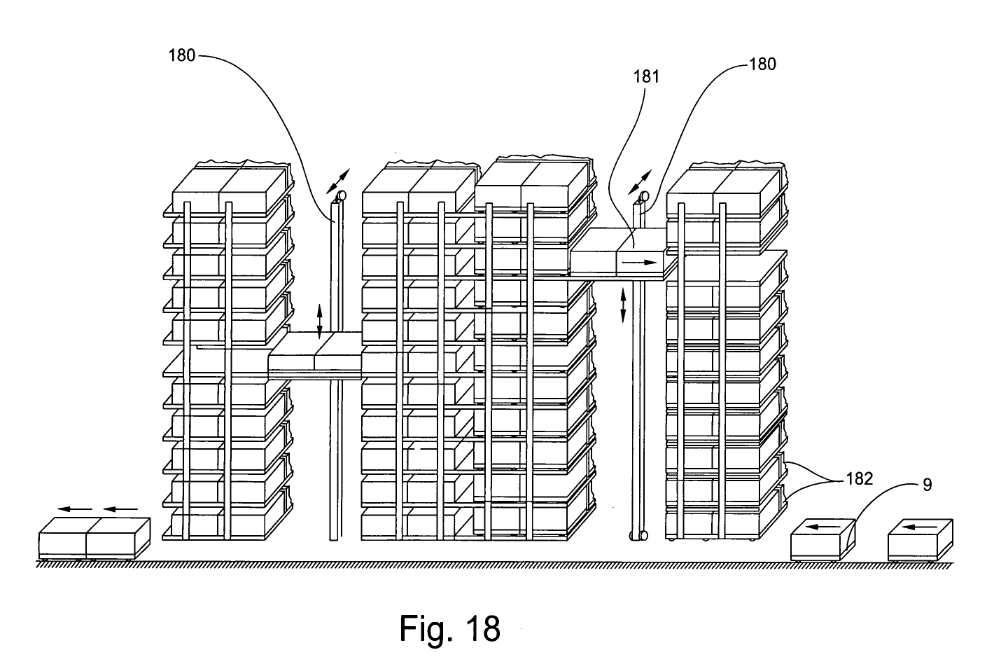

FIG. 18 shows another means of storing shuttles and/or storing, retrieving and/or transporting goods. In this embodiment, there are two lifts/cranes 180 that can lift a train of shuttles 181 (in FIG. 18 it is shown as a train of two shuttles, however, it is contemplated and within the scope of the instant invention that each of the lifts can accommodate fewer or more than two shuttles). In the shown embodiment, there are two cranes 180 that lift the train of shuttles 181. The shuttles can remain on any of the levels of the storage racks or, alternatively, the can place the goods on any given floor and then be recalled to the ground for transporting additional goods or alternatively sent to a different level in the racks to retrieve goods to be transported. Similar to FIGS. 12, 13, 14, 15A and 15B wherein shuttles were shown as being interlocked by arms 130 to support pallets 120, the shuttles can form trains automatically by using a pre-programmed algorithm, or alternatively, by using an interactive program that allows an operator to input data that links the shuttles together to form trains. Likewise, these aforementioned programs (either pre-programmed or interactive program) can be used to unlink shuttles from trains freeing up the shuttles for other purposes.

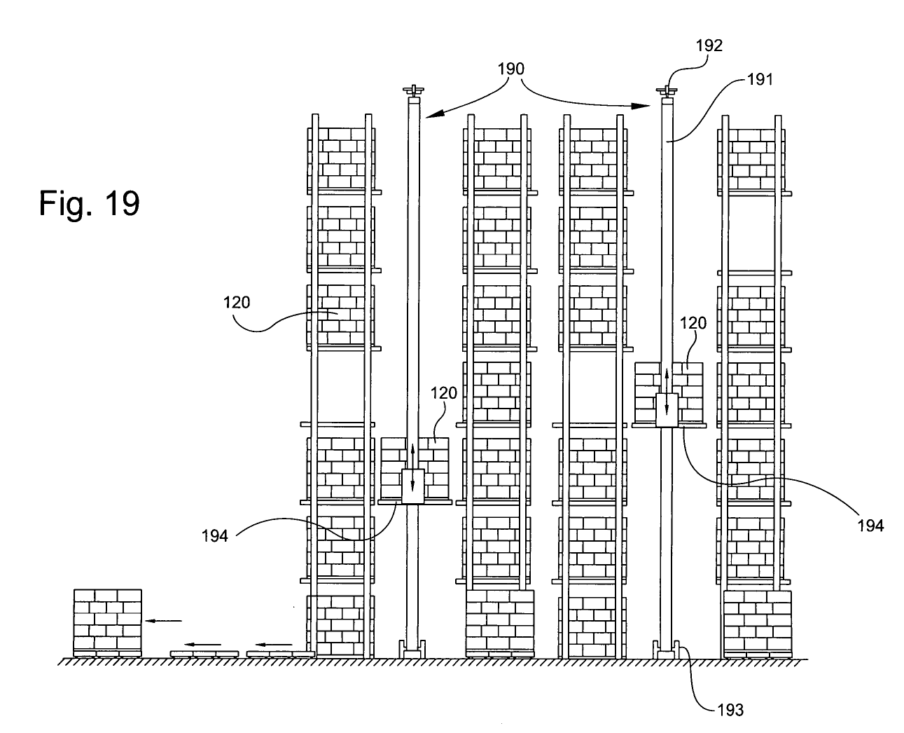

Conventionally, one had to go down an aisle to store/transport totes/cartons. The advantage of the shown system in FIG. 18 is that all of the lowest level positions 182 can be used as transfer positions. Totes can be deposited and retrieved more quickly (it is believed that throughput will increase up to 40% relative to the conventionally used method today). One does not have to travel down an aisle to deliver goods. One or more shuttles can travel on to cranes 180 and the cranes 180 lift the shuttles to the desired location(s). Alternatively, the shuttles do not have to travel on the crane 180 but rather the shuttles can deposit the goods directly on to the crane and the crane can transport the goods to the desired location where the goods can be deposited and/or retrieved. The crane 180 in FIG. 18 is shown as transporting smaller goods (such as totes). Bigger cranes are contemplated, for example as shown in FIG. 19.

FIG. 19 shows cranes 190 in a venue, for example, in a warehouse wherein the crane 190 can transport pallets 120 around. In the shown embodiment, the crane 190 is essentially a pole 191 that has a motor (not shown in detail) and a means of discerning its position in the venue. One can remotely communicate with the crane 190 to tell the crane 190 where to go to pick up pallets 120 and transport those pallets 120 to a desired location. In the shown embodiment, there is a wheel 192 at the top of the pole 191 which allows the crane to stabilize itself against the ceiling of the venue while at the same time allowing the crane to move around the venue. The top wheel can swivel so that it can go in a plurality of directions. In an embodiment, the crane may also have a wheel 193 at the bottom of the pole 191 to aid in transporting the crane around (although the wheel is not shown in the figure). A wheel 193 at the bottom of the pole is also able to swivel so that the crane 190 can go in a plurality of directions. In an alternate embodiment the crane may hang from the ceiling using a hanging means (such as by a hook that is disposed from the ceiling).

In an exemplary embodiment, the crane 190 can be pre-programmed so that the crane discerns in advance where it is supposed to go to lift and transport pallets 120 (or other size containers—see FIG. 18, for example), or alternatively, the crane can be programmed or given instructions interactively that allow the crane to adapt to changing circumstances.

In an embodiment, the interlocked shuttles as disclosed in FIGS. 12-15B transport a pallet 120 to a given location. The shuttles 9 can depose the pallet 120 on the floor in the venue and continue on to transport other pallets 120. Prior to unloading the pallet, the interlocked shuttles 9 communicate with the crane 190 to let the crane 190 discern the position of the pallet 120. When the crane 190 knows the position of the pallet 120, the crane 190 moves to the position where the pallet 120 on the floor is located. Once the crane 190 reaches the position where the pallet 120 is located, a lift 194 on the crane is able to pick up the pallet and then transport the pallet to a desired location. While the crane 190 is moving to the pallet 120, the interlocked shuttles 9 (as shown in for example FIGS. 12A-D) are sent elsewhere (either as still interlocked or not interlocked) to perform a different task. This provides for much more efficient use of the shuttles, which will provide for more rapid storage (and ultimately lower costs and/or higher efficiency). In FIG. 19, one pallet 120 is shown on each lift. However, it should be understood and it is within the scope of the invention that the crane(s) 190 can be designed to transport more than one pallet 120 at a time. In other words, the pole can have a means of supporting several pallets at one time. Alternatively, the crane can have multiple lifts 194 to accommodate multiple pallets 120. The crane 190 can then move with several of the pallets and depose each of the pallets in a desired location.

The advantage of the instant invention is that the crane 190 can travel to any of a plurality of positions wherein it can deliver or retrieve goods. There is no central in feed or out feed position as appears in the conventional methods of moving goods. Rather, the crane 190 is able to go to a plurality of positions. Thus, throughput is dramatically increased. The combination of the moving shuttles and the moving crane 190 will likely lead to throughput increases on the order of three times or more relative to the conventionally used system (of moving goods).

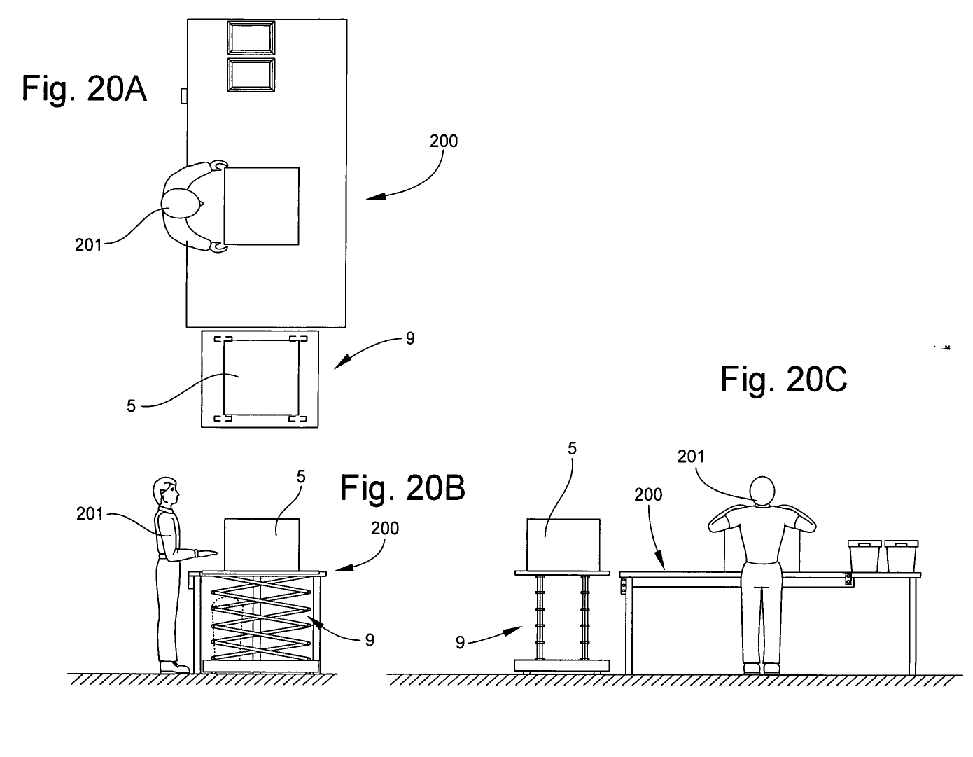

FIGS. 20A-C show a work station 200 wherein a person 201 may be present. FIG. 20A shows a top down perspective, FIG. 20 B shows a side perspective and FIG. 20C shows a perspective from the back. At the workstation 200, a shuttle 9 transports goods 5 to or away from the work station. In one embodiment, the shuttle 9 brings goods 5 to the workstation 200 and the person 201 at the workstation 200 can perform some function on the goods, for example, the person at the workstation 200 may wrap the goods in plastic wrap or perform some other function to the goods 5. When the person has finished the task, the shuttle 9 can transport the goods to the next workstation or alternatively, can send the goods to another desired location, such as to a tractor trailer for transportation to a desired location (see for example, the tractor trailer in FIG. 3).

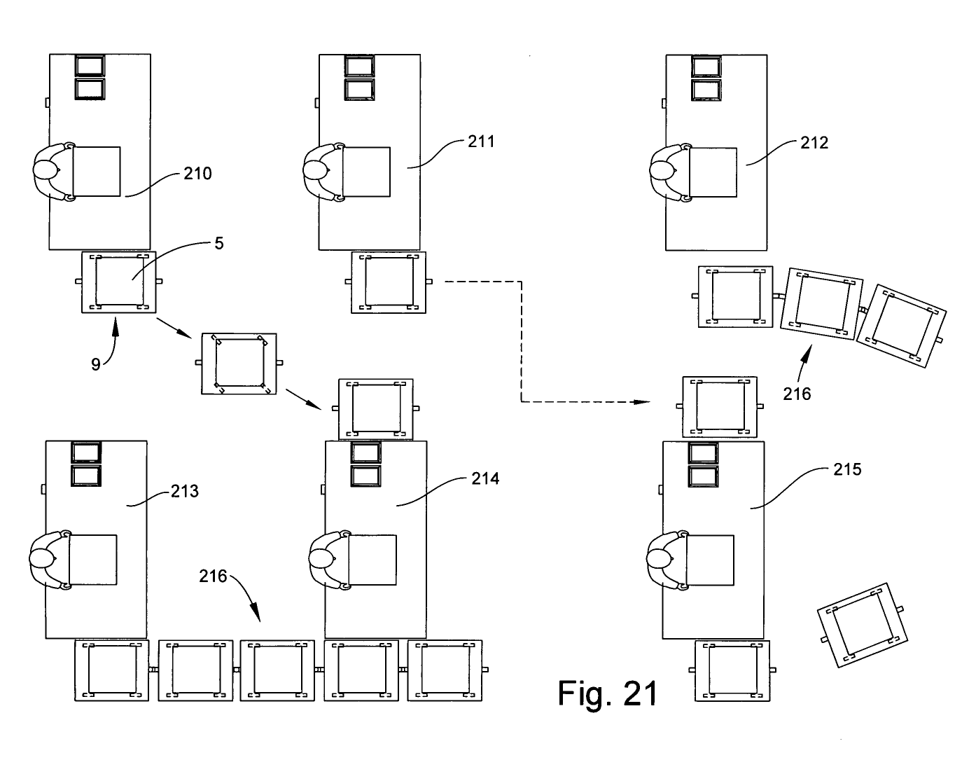

FIG. 21 shows a plurality of workstations 210-215 wherein goods 5 are transported by shuttle 9 from one workstation 210 to another 211-215. These workstations 210-215 may be in an area wherein value added tasks are performed such as gift wrapping, writing greetings cards (and associating them with totes and/or packages). The shuttles 9 movement can be preprogrammed so that the shuttles only go to certain work stations. Alternatively, the shuttles can be interactively programmed so that they can be sent to a given workstation as circumstances warrant. Because the shuttles 9 have swivel wheels and are equipped with a means of discerning their location, they can be sent in any of a plurality of directions. In one example, a shuttle 9 can be sent from workstation one 210 to workstation four 215 to workstation five 214. Alternatively, workstation four 215 can be skipped and workstation two 211 optionally inserted as a desired location.

Accordingly, the embodiment of the instant invention does not suffer from the drawbacks inherent in using the conventional technology of conveyors wherein goods can be transported serially from point A to point B, but are unable to be transported easily to locations that are not serial in nature (e.g., to locations that are parallel in nature). FIG. 21 shows a shuttle going diagonally from workstation one 210 to workstation five 214. Thus, absent using a multitude of expensive conveyors or equally expensive human labor to transport goods to a series of parallel locations, the instant invention can process goods from one workstation to another far more efficiently and inexpensively than the means used conventionally.

At the bottom of FIG. 21, trains 216 can also be seen that can transport a series of goods from one workstation to another. In FIG. 21, the goods are going from workstation six 213 to workstation five 214 (or alternatively, from workstation five 214 to workstation six 213). It should be understood by those of skill in the art that any of a plurality of designs is possible and the shuttles and/or shuttle trains can travel to and/or skip any of a desired number of workstations.

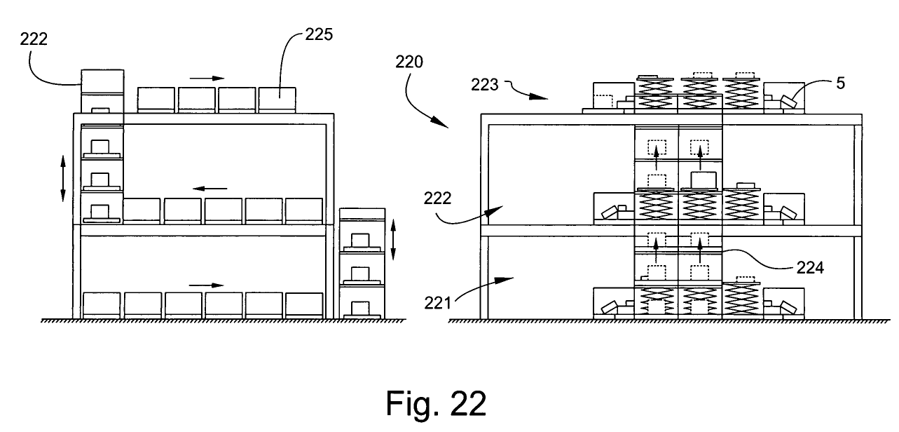

FIG. 22 shows an endless multilane multilevel parallel sorter 220. This sorter is advantageous over those that are in conventional use today in that a plurality of levels 221-223 can be used to sort goods (either batch sorting or sorting for individual orders). This allows the use of vertical space which is not conventionally in use today. The sorter can work in combination with chutes (not shown in FIG. 22 but shown in FIG. 6, for example) to sort goods at a rate that is on the order of 4 times as fast as the conventionally used systems today. Moreover, not only is the sorter able to advantageously use vertical space, but there can be many different aisles and/or lanes that allow the shuttles 9 to take advantage of space in both a length direction as well as in a width direction. Many different sort destinations can be used by employing the multilevel sorter as shown in FIG. 22. Although three levels 221-223 are shown in FIG. 22, it should be understood that any number of levels can be used. Continuous lifts 224 or incline/decline conveyors are used in the multilane, multilevel sorter 220 to transport the shuttles up or down to a level below or above. There can also be lifts (not shown) that are dedicated to bringing the shuttles down levels (or back to the floor).

Moreover, the sorter 220 as shown in FIG. 22 can be configured in any of a plurality of ways to meet the requirements of a warehouse at a particular time. Additional levels and/or shuttles can be added or removed. Additional levels and/or shuttles may be added when high good throughput sorting is needed and removed during times when the good throughput sort rate is slower. For example, during late summer months when back to school supplies are needed in quantities that exceed other times of the year, the multilevel, multilane shuttle system can have additional levels added, that can be effectively used to batch sort (or individual order sort) goods. The shuttles may bring a plurality of notebooks, backpacks, pencils, pens, and other school supplies, which can effectively be batch sorted by the multilane, multilevel sorter 220 so that a given store has the supplies that it needs. Empty cartons 225 may be transported to the multilane multilevel sorter that are able to accommodate the goods 5 that are to be sent to a given location. The multilane, multilevel sorter can also be configured in a way to meet any of a plurality of needs.

The sorters in conventional use today are not easily adaptable to peak throughput sorting needs. Typically, in conventional systems more hires (i.e., people) are needed at times when higher throughput is required. The automatic sorters that are conventionally employed also are not easily configured into other configurations. They tend to have hardware that is not changeable (for example, conveyors, tracks, etc.) that are not easily reconfigured. This means that reconfiguration has the added drawback of being very expensive. The shuttle system of the instant invention when used in combination with the multilane, multilevel sorter 220 formation however is quite adaptable as the shuttles are able to bring any of a plurality of goods to the sorter, additional shuttles can be utilized as needed (or alternatively taken away during slow sorting times), and additional levels can be added and removed as needed. Thus, the modular multilevel multilane sorting system is much less expensive and adapts easily to constantly changing processing conditions.

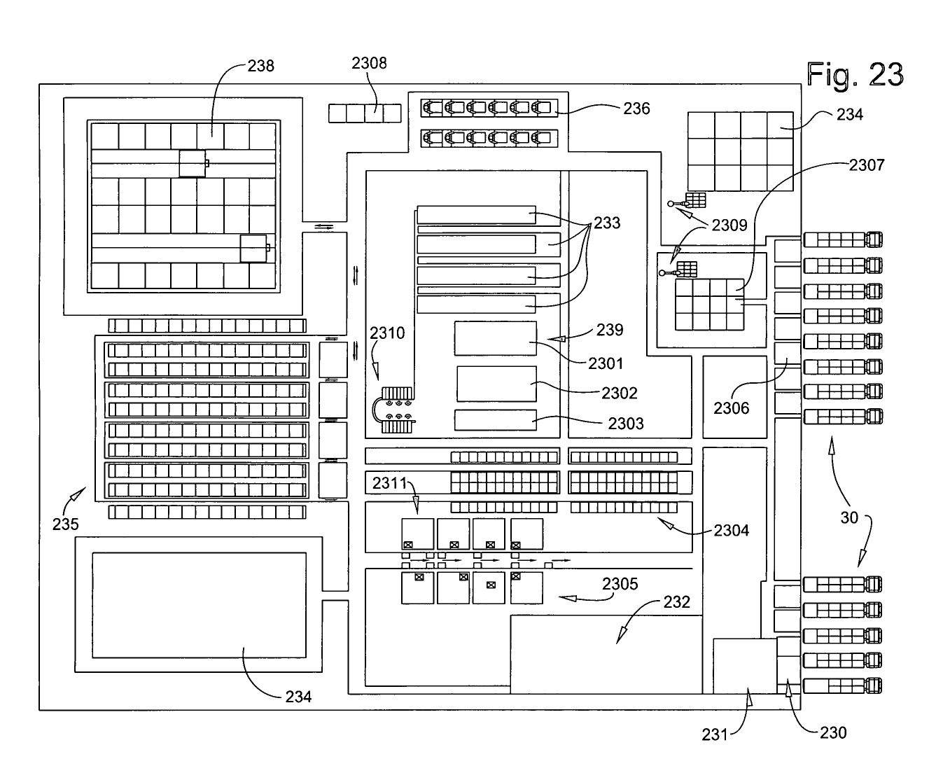

FIG. 23 shows an exemplary embodiment of a warehouse layout employing many of the features that are discussed in the instant invention. The shown warehouse is just one of many of thousands of possible ways that the systems disclosed in the instant invention can be integrated. FIG. 23 displays figure numbers by each of the respective systems to show where that system is shown in greater detail. Thus, for additional details on each of the respective areas, the reader is advised to refer to the sections in this application that describe those figures.

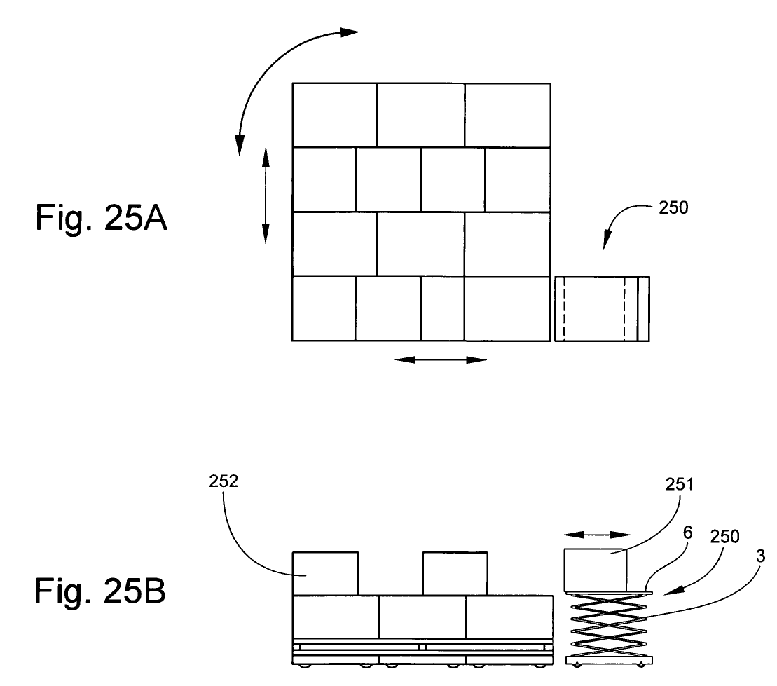

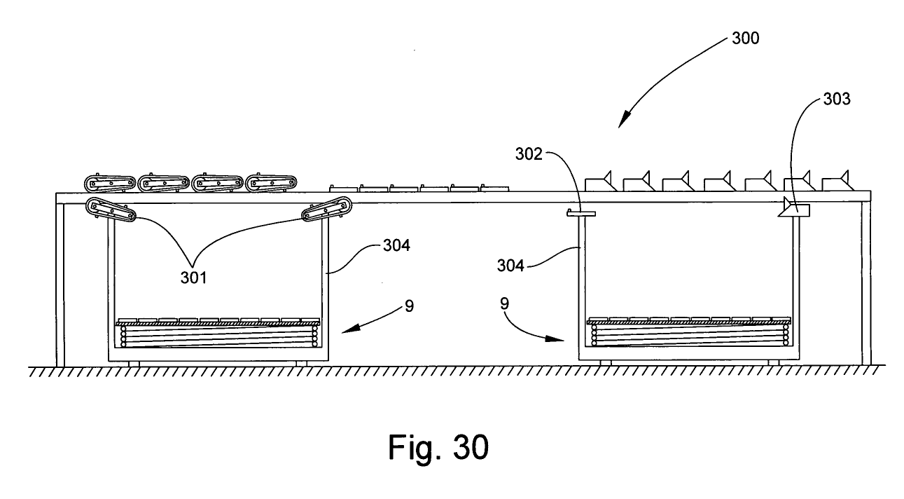

The numbers that appear in FIG. 23 refer to different parts of the invention. The numbers also correlate with different figures in the invention. Generally, the following numbers represent parts of the invention that can be seen in more detail in the following figures: (Please note that the text (i.e., the number) prior to the dash in each of the following series refers to a part in FIG. 23 and the text after the dash refers to the figure(s) in which this part of the invention is better shown); 238-FIGS. 19, 26 and 27; 235-FIG. 17; 237-FIG. 18; 2308-FIG. 16; 236-FIGS. 20 and 21; 233-FIGS. 2 and 8; 2301-2303-FIGS. 2 and 30; 2310-FIGS. 28A and 28B; 2304-FIGS. 9, 10, and 22; 2309-FIGS. 24 and 25; and 30-FIG. 3.

FIG. 23 shows tractor trailers 30 that are near the receiving area (in the bottom right hand comer of the figure). Shuttles can be transported to the receiving area 230 to receive goods. Generally, once the goods are received from a tractor trailer 30 (or alternatively, a boat, train, etc.), some of the received goods are spot checked in the quality check area 231 (for example, to ascertain that the correct quantity of goods is received in an individual carton, or to ensure that the goods are not defective). Generally, the quality check area 231 will be outfitted with several workstations (see for example, the workstations 200 in FIGS. 20A-C) wherein employees will spot check typically on the order of about 1% of the received goods (although this percentage can and does change dependent upon conditions). The shuttles bring all goods to and take away all goods from the quality check area 231.

In the receiving area 232, there may be employees that determine where to store goods (if they are to be stored). For example, in the receiving area 232 decisions are made such as whether to put the goods in pallets or cartons, or alternatively whether long term or short term storage is needed, or whether quick access will be needed to the goods. After these decisions are made, the goods that have been spot-checked and the goods that are not spot checked can then be transported by the shuttles to any of a plurality of areas in the warehouse. For example, they can be sent to replenish the A frame 233 or to the area where outbound pallet 234 build-up can occur (i.e., crossdocking). Alternatively, the goods may be sent to one of the storage areas wherein goods can be stored, such as one of the plurality of modular racks 235. Other locations where the goods can be sent include one of the workstations 236 for performing additional functions or to a conveyor or a sorter for additional sorting and/or processing.

The warehouse floor can be adapted to have any of a plurality of configurations. These configurations may contain any number of the features that are described elsewhere in this application and exemplarily illustrated in the figures. Thus, a warehouse can be configured so that it can perform any one or more of the given functions: transportation, storage, retrieval, picking, sorting, pallet handling, tote handling, carton handling, material flow control, dispatch, palletizing, full case and broken case handling, automated picking, manual picking, and replenishment functions.

Many of these functions are shown in FIG. 23. Accordingly, in the configuration shown in FIG. 23, the AS/RS (Automatic Storage/ Retrieval System) 237 can be used for totes or cartons wherein goods can be quickly retrieved. Alternatively, the goods can be sent to the pallet area 238 which stores unit loads (i.e., pallets) if they are received as pallets or pallets have been built by the stacking of cartons. The goods when needed from either of these areas can be stored and retrieved in any sequence. Both of these areas may also have cranes in them on tracks, where the shuttle can park (i.e., deposit) the goods for storage and/or alternatively be retrieved by the crane(s) and/or shuttles when the goods are needed (see FIG. 19, for example). It should be apparent that a warehouse can be configured so that goods can be transported, stored, picked and retrieved much faster than the conventionally used methods of transporting, picking, retrieving and storing goods.

When goods are retrieved from one of the storage areas (for example, after an order is received) they can be transported by the retrieving shuttles to any of a plurality of locations. For example, they can be sent to the value added services workstations 236 (shown in FIG. 23) where the goods can be gift-wrapped, and a greeting card associated with the gift-wrapped goods (or any of a plurality of other functions can be performed).

Alternatively, when goods are retrieved from one of the storage areas, the goods can go to the picking area 239 (Split Case Picking), wherein they can be picked and/or sorted by the machines that are used for picking, for example, A-frames 233, MRS machines 2301 (a picking robot), LMS machines 2302 (a dispensing machine which operates at about half the speed of an A-frame but is considerably less expensive than an A-frame) or TD lean machines 2303 (which are used for picking goods that are needed less frequently). Alternatively, the goods may be picked manually (as shown in FIG. 6) for example, when the goods are fragile or are of unusual shape (e.g., incontinence products).

Alternatively, when goods are retrieved, they can be sent to a sortation system wherein goods can be sorted to store the goods or alternatively sorted to send out (for example, batch sorted to send to a store). Goods that come to the sortation area 2304 may also be returned goods where they can be processed and sent to the correct location for storage or for other needs. Defective goods that are returned from an order generally are sent to the quality check area 231 wherein personnel at the quality check area will make a decision as to what to do with the goods.

The full case picking area 2305 is used when, for example someone orders 28 pairs of jeans. A typical carton may contain 10 pairs of jeans. Thus, the full case picking area 2305 will combine 2 cartons of jeans and 8 individual jeans into a third carton (which may have been picked at, for example, at the manual pickstation). The carton containing the 28 jeans can then be transported to any of a plurality of locations (for example, the loading dock 2306). The inverted shuttle as described in FIG. 28 may be used at the loading dock 2306 or at the full case picking area 2305 (alternatively, the inverted shuttle can be used at the value added services workstation 236). The Pallet Build-up 234 and Mixed SKU Pallet areas 2307 are used for packing pallets that may be uniform (all goods are similar of the same) or alternatively not uniform (a diverse plurality of goods are made into pallets). The auto stacker area for shuttles (as shown in FIG. 16) is shown as 2308. The palletizing robot (which is shown in detail in FIG. 24) is represented by 2309.

FIG. 24 shows a palletizing robot 240 that is able to move cartons from a conveyor 241 to shuttles 9. The shuttles 9 may be interlocked in order to support the pallets (as previously disclosed in FIGS. 12A-D). The palletizing robot can have any of a plurality of means for picking up cartons and/or goods. Means for picking up cartons and/or goods include such devices as suction cups, hooks, dual hydraulic arms, etc. After the cartons and-or goods are picked up they are placed on the shuttles to generate pallets 120. The palletizing robot 240 preferably is able to rotate at the base 242 so that it can place the carton at any of a plurality of locations when it makes the pallet 120. It should be apparent that the shuttles, which contain the pallet that is being made, also are able to move, meaning that the palletizing function is not limited by the distance that can be reached by the palletizing robot. Due to the ability of the shuttles to move, rotate and lift the pallets, it is possible to stack totes or cartons in desired layers and sequence. By being able to place totes and/or cartons in the desired layers and sequence, this will allow one to facilely map retail shelf so it is floor ready as previously described.

A smaller version of a palletizing robot 240 can be adapted to fit on the goods supporting platform 4 of a shuttle so that a shuttle can pick up goods and then transport the goods where they are needed. Alternatively, a shuttle that is configured with a smaller version of a palletizing robot 240 may optionally place goods that have been picked up on to a second shuttle that has a cross belt 6, a goods supporting platform 4, a dispenser, on any of a plurality of other devices as described herein. Any of a plurality of robot arms and/or other devices can be placed on a shuttle that will allow a shuttle to pick up goods for transport and/or to perform some other function with the shuttle (such as palletizing).

FIGS. 25A and 25B show palletizing a pallet with a shuttle 250. FIG. 25A shows a top down view and FIG. 25B shows a side view. A shuttle 250 supporting a carton 251 can approach a pallet 252 that is being made and can deposit the carton 251 at any of a plurality of places on the pallet 252 that is being formed. The shuttle 250 supporting the carton 251 is able to move to the location wherein the carton is to be placed, raise the carton to the desired level using the scissors lift 3, and deposit the carton on the pallet that is being made (using a cross belt 6 or any other means of moving the carton horizontally off the shuttle). During this process, it is also possible that the palletizing shuttle 250 remains in a static position and the pallet 252 on shuttles moves/rotates and lifts to accommodate the palletizing process.

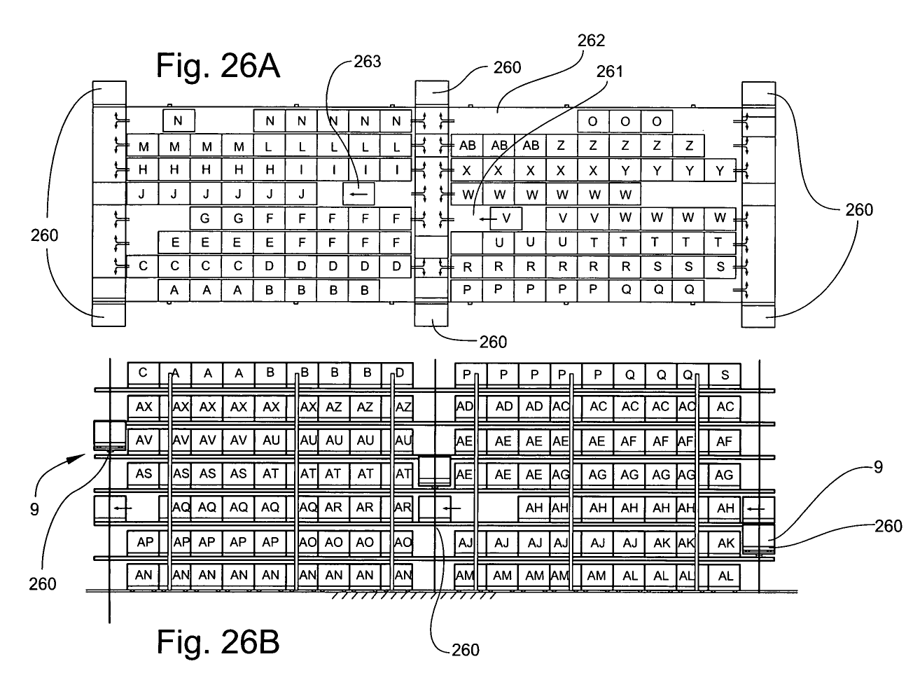

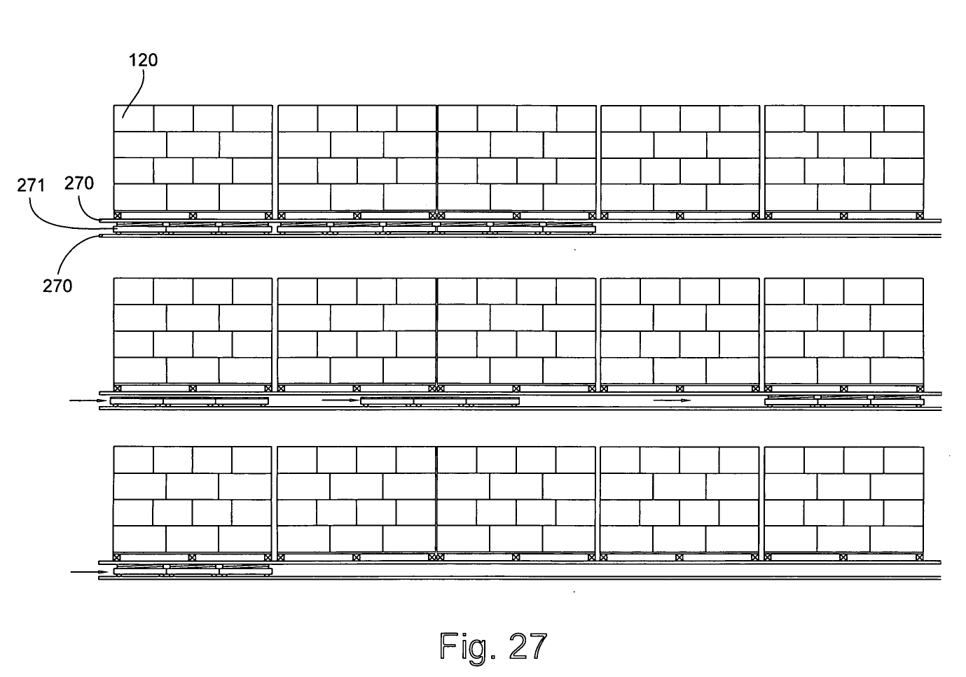

FIGS. 26A,26B, and 27 show a (Pallet) Storage and Retrieval System and a means for accessing pallets using shuttles, respectively. In FIG. 27, it is shown that pallets may be stored in a section wherein tracks 270 are used to support the pallets 120. These tracks 270 are spaced apart at a distance that allows the tracks 270 to support the pallet while allowing the shuttle 271 access to the pallet (these tracks are similar or analogous to an automotive oil change place wherein one drives the car up on tracks that support the wheels, while allowing access to the underside of the car). The shuttles 271 are able to travel under the tracks to a pallet on either end that is to be removed. Once the shuttles 271 reach the location of the pallet 120 to be removed, the shuttles lift the goods supporting platforms 4 to lift the pallet off of the tracks 270 and then the shuttles 271 supporting the pallet transport the pallet to the desired location. The pallet access mode system as described allows access to pallets at both a proximal end and a distal end of a line of pallets. Thus, the shuttles can remove one or more pallets (more shuttles may be interlocked together to remove more than one pallet) from either a distal end or a proximal end. FIG. 27 shows that the pallets may be stored on a plurality of floors (in FIG. 27, three floors are shown). Although, it is not shown in FIG. 27, a plurality of aisles and/or highways may be present on each floor that allows shuttles to bypass each other. In an example, if one needs a pallet that is on the third level in the second row and the second pallet from the distal end (i.e., the most distal pallet), two sets of interlocking shuttles may be sent up to the third level by a shuttle lift. The two sets of shuttles (i.e., a first set and a second set of shuttles) will travel to the second row. The first set of interlocked shuttles would remove the distal pallet and travel down an aisle, which allows the pallet to be temporarily stored. The second set of interlocked shuttles removes the second pallet from the distal end. The second set of interlocked shuttles holding the second pallet from the distal end proceeds down a lift to the ground floor on a lift that is dedicated to bringing pallets down. The first set of interlocked shuttles holding the most distal pallet may then deposit the shuttle back on the tracks in the position where the second most distal pallet was previously (or alternatively, it can place the second most distal pallet in another location).

The pallet access mode system as described allows much more rapid access to pallets than the conventional systems that are in use today, which conventionally only allow access from one end of a row of pallets. Thus, if there are five pallets in a row (as is shown in FIG. 27) and one needs the fourth pallet, in the conventional system, the first three pallets must be removed to access the fourth pallet. Thus, access to pallets in the traditional system is retarded relative to the instant invention's pallet access embodiment (wherein the fourth pallet can be accessed from the distal end, which means only the distal pallet needs to be moved for access to the fourth pallet). Conventional throughput of retrieving pallets is about 200/hr. The instant invention has throughput of retrieving pallets that is on the order of more than 1000/hr (about 2000/hr.)

The design of the tracks allows a plurality of pallets to be accessed and/or retrieved at one time. For example, the last two pallets in a row may be needed to be retrieved. By combining a sufficient number of interlocked shuttles, two pallets can easily be retrieved (or more). The conventional system of using forklifts and only being able to retrieve a single pallet from a proximal end is much slower for several reasons. First, pallets are only retrieved from one side. Second, pallets can only be retrieved one at a time. Third, unless one has more than one forklift (which is very expensive), a forklift that is trying to retrieve the second proximal pallet in a row has to retrieve the first pallet, deposit the first pallet in a location wherein it is out of the way, go back to retrieve the second pallet, retrieve the second pallet, transport the pallet where it is required, and then go back and position the first pallet back where it was. The shuttle system of the instant invention does not have any of these drawbacks because a warehouse is likely to have a plurality of shuttles that can perform all of these functions simultaneously.

FIGS. 26A and 26B shows a top down view and a side view of a plurality of levels and aisles wherein the pallets that are stored on the above described tracks. The top down view as shown in FIG. 26A shows that there are a plurality of rows 261 containing pallets as well as a plurality of passageways 262 that allow the shuttles to freely move around on a given level. By observing the top down view, it should be apparent that one can have six lifts 260 (the two that are marked on the right side of the figure, two in the center section and two in the corners on the left side of the pallet storage and retrieval area). The shuttles 9, once they arrive at the level where needed can travel across the width of the pallet storage and retrieval area (see the arrow 263 showing the movement of the shuttle on the left hand side of the figure). When the shuttles arrive at the correct row they can proceed under the tracks (that are better shown in FIG. 27) to remove that desired pallet. There are passageways 262 that allow a first set of shuttles to temporarily store a pallet while a second set of shuttles may remove the pallet that is needed. Thus, the first set of interlocked shuttles can avoid the second set of interlocked shuttles that are supporting the pallet that is needed.

FIG. 26B shows a side view of the length of the pallet storage and retrieval area. Lifts can be seen on the right hand side, the center, and the left hand side of the length of the pallet storage and retrieval area. It should be apparent that the lifts can deliver the shuttles 9 to the desired level. One or more lifts may be dedicated to bringing shuttles up levels and one or more lifts may be dedicated to bringing shuttles down levels. It is contemplated that one may be able to change the direction of the lifts as needed.

FIGS. 28A and 28B show embodiments wherein shuttles 9 are inverted. The inverted shuttles 9 may contain any of a plurality of mechanisms in which they can transport goods, such as hooks 284 and/or suction cups and or an handling device 285 , or other means. One means of inverting the shuttle is by travel on a rail 280 and vertical conveyor 283 which transports the shuttles from the floor 281 to the roof 282 (see FIG. 28). This may be important in many industries, such as in the automotive industry where a heavy part can easily be positioned to a given location by transporting it on the ceiling. This means that an employee will not have to lift that heavy part (for example, an automotive engine). Places wherein the inverted shuttle system is likely to have use is at the value added services workstations 210 (see FIG. 21) or at the Full Case picking area 2305 (see FIG. 23). In FIG. 28B, an overhead grid 287 is shown, which represents the rails 280 upon which the inverted shuttles 9 travel. From close inspection of FIG. 28B, it should be apparent that the shuttles can travel in a plurality of directions, that many different shuttles can be present on the overhead grid 287, and that if two or more shuttles 9 are present on the overhead grid 287, the shuttles can easily bypass each other. Although the overhead grid 287 is shown with 4 rails in the vertical and horizontal direction, it should be apparent that any number of rails may comprise the overhead grid 287 system.

It is contemplated that the overhead grid 287 system and the inverted shuttles 9 may be ideally suited to unpacking pallets. The inverted shuttle 9 can remove a good from a pallet, wherein the pallet is on a first set of interlocked shuttles. The inverted shuttle 9 can then deposit the unpacked good (from the pallet) to the needed location. Subsequently, the inverted shuttle 9 may move to a new pallet to remove a good from that pallet. Alternatively, the pallet may travel to the position where the inverted shuttle is present (or alternatively, the inverted shuttle and the pallet may both travel to an alternative location wherein the pallet is partially unpacked). It is contemplated that the inverted shuttle system may also be ideally suited for the grocery industry, particularly employing suction cups.

An inverted shuttle 9 may also pick up a good and then subsequently, move along the rail to the ground wherein it can transport the good to the desired location. The inverted shuttle system (and the shuttle system in general) is ideally suited for parallel processing and/or transporting of goods.

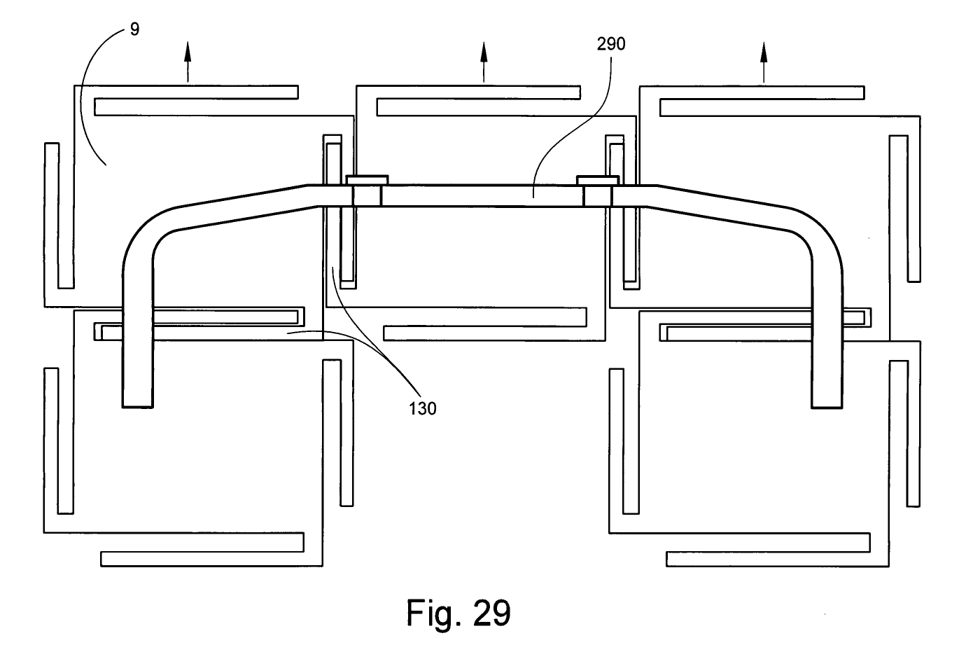

FIG. 29 shows that the shuttles 9 can be interlocked in any of a plurality of ways so as to be able to transport any of a variety of unusually shaped goods. In FIG. 29, five shuttles 9 are shown as being interlocked by arms 130 so that they can transport an automobile or vehicle bumper 290. The ability to form any shape by interlocking the shuttles eliminates greatly the time consuming manual handling of “non conveyables”. In a warehouse, often up to 20% of goods cannot be transported on conveyors for reasons of shape, size, weight, form or other factors.

FIG. 30 shows a dispenser docking station 300 for shuttles. A shuttle 9 typically travels to the docking station 300 where any of a plurality of dispensing units 301-303 can be affixed to vertical arms 304 present on the shuttle. In FIG. 30, two A-frame dispensers 301 are shown as being affixed to vertical arms 304 on one shuttle 9 and an LMS dispenser 303 and a MDS dispenser 302 is shown as being affixed to vertical arms 304 on a second shuttle. When the shuttles no longer need the dispensers 301-303 that are affixed to them, they will return to the docking station 300 wherein the dispensers will be removed and returned.

FIG. 31 shows a battery replacement docking station 310 wherein a shuttle 9 with a discharged or partially discharged battery 311 will exchange this battery for a battery that has been fully charged (fully charged battery 312). The shuttle 9 will have a means of sensing when battery power is low and travel to the docking station 310 wherein it will exchange its fully or partially discharged battery 311 for a fully charged battery 312. The docking station ideally will posses a power source 313 that will allow a discharged battery 311 to be connected to a charger (not shown) that recharges the battery and then makes the battery available for re-use for another shuttle.

It should be apparent to those of skill in the art that it is easy to expand to add or subtract any of the features as previously discussed. One way of expanding is to purchase additional shuttles, which should allow a venue to not only transport more goods, but also allow a venue to transport, store, load, and unload goods more rapidly and more efficiently. Moreover, if one transports goods to a different location (for example, to a larger location as a business may grow), it is easy to move the shuttles to the new location. Conveyor systems, in contrast, are difficult and often prohibitively expensive to move to new locations.

As was disclosed previously, an advantage to the shuttle system of the instant invention is that the shuttle system is not dependant on the often prohibitively expensive conventional conveyor layout anymore. This is particularly evident in instances where an order for multiple goods is received and some of those goods are not on location and/or arrive late at the location. Generally, the goods on location will be packed. However, one must wait for the goods that are not yet on location (i.e., late arriving goods) to complete the order. Generally, these late arriving goods are required to be sorted and packed manually with a given order because dedicating a conveyor system to these late replenishments to complete orders would be prohibitively expensive. Pick stations, where the goods are conventionally processed manually for a given order, can be visited multiple times, which is also prohibitively expensive (due to the amount of human labor needed). The shuttle system as disclosed in the instant invention does not suffer from the costs or drawbacks associated with conveyors and/or human labor costs. The shuttle can be pre-programmed to recognize a bar-code on a given late arriving good, pick up that good when it arrives, and transport that late arriving good to the appropriate order to complete the order, whereupon the order is then shipped to the desired location.

One additional advantage to the use of shuttle systems is that several different distinct warehouses can be connected together by the transporting shuttles. Although it is possible to connect different warehouses by a conveyor system, conveyor systems have the drawback of semi-permanently being in the same place. Thus, to connect warehouses wherein the goods are transported outside (in traveling from one warehouse to another), the semi-semi-permanent conveyor system suffers the drawback of semi-permanently being exposed to the elements, leading to rust and mechanical breakdowns (or alternatively, requiring the use of prohibitively expensive tunnels to protect the conveyor system from the elements). In contrast, the shuttle system of the instant invention does not suffer from the drawback of being semi-permanently outside. Goods can be transported when desired (for example, when the weather is good). In any event, the shuttles are never exposed to damaging weather for long periods of time. In the same way that different warehouses can be connected together, a manufacturing plant can be connected to a warehouse in the same way. A shuttle can be pre-programmed or alternatively, interactively programmed to wait for a manufactured good. When manufacture of the good is complete (which can be signaled to the shuttle by the incorporation of an RF-ID chip on the good), the shuttle can pick up the good(s) and transport the good(s) to the warehouse for filling an order. It is contemplated and within the scope of the present invention that any of a number of possible combinations are possible. One might envision combining an Office with a warehouse wherein a shuttle is instructed to wait for a good from an Office worker and once the good is ready and/or manufactured the shuttle transports the good to the Office worker.

The shuttle system of the instant invention is also advantageous in that it is easy to adapt the system to changing circumstances. Because shuttles can be sent where needed, the system is able to handle increases in goods that need to be transported, or alternatively, during slow periods where a decrease is warranted, the shuttles can be put in one of the storage areas that was described above with reference to the drawings (see for example, the stacker 160 as shown in FIG. 16).

Although the above shuttle and shuttle system was described primarily in relation to a warehouse, it is contemplated that the shuttle system can work in a plurality of locations, for example, in an airport to transport luggage, in Office buildings transporting mail, mail/postal processing hubs to transport mail (for example UPS, FED EX, the United States postal Service, etc.), in document storage facilities, in hospitals transporting food or other goods, in libraries to transport, store, and retrieve books, in an automotive factory to transport, store, and retrieve automotive parts, in retail stores replenishing shelves, in harbors or loading docks to transport, store, and retrieve goods, in vehicles to transport, store, and retrieve goods including but not limited to trains, trucks, buses, ships, or other vehicles that are known to transport goods, transporting goods from an Office to another Office, or any of a plurality of other locales.

It should be apparent to those of ordinary skill in the art that the shuttles of the instant invention can perform a plurality of functions, including the following advantages: shuttles can bypass, shuttles can sort, shuttles can perform picking tasks, shuttles can change picking routes and tasks depending on the situation, shuttles can be free roaming, the shuttles can push and pull, the shuttles can build formations to sort, store, and retrieve, the shuttles can dynamically travel the shortest route based on actual processing and traffic conditions, the shuttles can adapt to different type Autopicker Designs, the shuttles can connect to adapt various shapes the shuttles can be used in sorting platforms, Picking Dispensers, handling device, etc. the shuttles can travel on conveyors or in conjunction with conveyors, the shuttles can stack or can be stacked and/or de-stacked, the shuttles can be intelligently routed, sequenced and multiple tasks can be performed with same shuttle, the shuttles can be charged in Stacker or multiple Zones, the shuttles can help other shuttles to perform certain tasks. These functions/processes were all described above.

Two additional advantages of employing the shuttles of the instant invention is that no wiring is required in a warehouse or locale where the shuttles are to be employed, and there is no expensive installation labor needed for shuttles. The shuttles can simply be acquired as needed depending on the size of a locale, the tasks to be performed, etc.

It is contemplated and considered to be within the scope of the instant invention that any feature of the present invention can be combined together with any other or combination of features. The instant invention is directed to products/apparatuses, methods, systems, and processes wherein the shuttles are employed. Any of the features discussed in this application can be a feature in any claimed product/apparatus, method, system, and process. Thus, it should be apparent to those of skill in the art that the instant invention is not to be limited by the exemplary embodiments but is rather to be defined by the following claims. When a method is indicated in the below claims, it should be understood that the steps in the method can be arranged in any order.

I claim:

1. A goods transporting shuttle comprising a plurality of wheels and swivels, wherein the number of swivels and wheels are equal, and wherein each of said swivels is attached to each of the wheels which allow the shuttle to travel on the wheels in a plurality of directions, wherein said swivels are attached directly or indirectly to a lift supporting platform, said lift supporting platform supporting a lift, and wherein said lift has the ability to expand and contract so as to lift or lower a goods supporting platform that can support goods to be transported, the shuttle also containing one or more motors wherein said one or more motors is/are used to transport the shuttle and/or operate the lift.

2. The shuttle of claim 1, further comprising at least one RF-ID chip for ascertaining the position of the shuttle and/or communicating with a computer.

3. The shuttle of claim 1, wherein the lift is a scissors lift.

4. The shuttle of claim 2, wherein the lift is a scissors lift.

5. The shuttle of claim 1, wherein a computer is associated with the shuttle.

6. The shuttle of claim 4, wherein a computer is associated with the shuttle.

7. The shuttle of claim 6, wherein the computer is at a location that is remote from the shuttle, said computer being able to communicate with the shuttle so as to instruct the shuttle to perform tasks.

8. The shuttle of claim 6, wherein the shuttle has the ability to connect with a second shuttle and said shuttle and said second shuttle are able to transport together in concert.

9. The shuttle of claim 6, wherein the shuttle contains four wheels, said one or more motors include at least one electric motor, and said computer contains a means of inputting an algorithm or a computer program.

10. A system for transporting goods, said system comprising a goods transporting shuttle, said shuttle comprising a plurality of wheels and swivels, wherein the number of swivels and wheels are equal, and wherein each of said swivels is attached to each of the wheels which allow the shuttle to travel on the wheels in a plurality of directions, wherein said swivels are attached directly or indirectly to a lift supporting platformn, said lift supporting platform supporting a lift, and wherein said lift has the ability to expand and contract so as to lift or lower a goods supporting platform that can support goods to be transported, the shuttle also containing one or more motors wherein said one or more motors is/are used to transport the shuttle and/or operate the lift.

11. A method of automatically transporting goods from a first location to a second location by shuttle, said method comprising:
sending a shuttle by remote instruction to a first location containing goods, the shuttle picking up the goods at said first location, and sending said shuttle by remote instruction to said second location, thus transporting the goods.

12. The method of claim 11, wherein said shuttle comprises a plurality of wheels and swivels, wherein the number of swivels and wheels are equal, and wherein each of said swivels is attached to each of the wheels which allow the shuttle to travel on the wheels in a plurality of directions, wherein said swivels are attached directly or indirectly to a lift supporting platformn, said lift supporting platform supporting a lift, and wherein said lift has the ability to expand and contract so as to lift or lower a goods supporting platform that can support goods to be transported, the shuttle also containing one or more motors wherein said one or more motors is/are used to transport the shuttle and/or operate the lift.

13. The method of claim 11, further comprising deposing the goods at said second location.

14. The method of claim 12, further comprising deposing the goods at said second location.

15. The method of claim 11, wherein either or both of said first location and said second location is in a warehouse.

16. The method of claim 15, wherein both of said first location and said second location is in a warehouse.

17. A locale comprising the shuttle of claim 1.

18. The locale of claim 17, wherein the locale is one or more members selected from the group consisting of in an airport, an office building, a storage facility, a hospital, a library, an automotive factory, to a retail store, a harbor, a loading dock, inside vehicles, and outside vehicles.

19. The locale of claim 17, wherein the locale is a building.

20. The locale of claim 19, wherein the building is a warehouse.
